(19) United States
(12) Patent Application Publication
(10) Pub. No.: US 2023/0354902 A1
(43) Pub. Date: Nov. 9, 2023

(54) STACKED SUSCEPTOR STRUCTURE

(71) Applicant: Philip Morris Products S.A., Neuchatel (CH)

(72) Inventors: Guillaume FREDERICK, LesGeneveys-sur-Coffrane (CH); Ihar Nikolaevich ZINOVIK

(73) Assignee: Philip Morris Products S.A., Neuchatel (CH)

(21) Appl. No.: 18/245,637

(22) PCT Filed: Sep. 21, 2021
(86) PCT No.: PCT/EP2021/075978

§ 371 Date: Mar. 16, 2023

(30) Foreign Application Priority Data
Sep. 23, 2020 (EP) 20197780.8

(51) Int. Cl. A24F 40/465; A24F 40/10; A24F 40/42; A24F 40/485; A24F 40/44

(52) U.S. Cl. CPC A24F 40/465; A24F 40/10; A24F 40/42; A24F 40/485; A24F 40/44

(57) ABSTRACT

An electrically heatable aerosol-generating system is provided, including: at least one inductor coil; a power supply connected to the coil and configured to provide an alternating current to the coil to generate an alternating magnetic field; a housing containing a reservoir of aerosol-forming substrate; and a substantially planar susceptor assembly configured to be heated by the alternating magnetic field and including a first susceptor element, a second susceptor element, and a wicking element in fluid communication with the reservoir, the first and the second susceptor elements being integral with or fixed to the wicking element, a space being defined between the first and the second susceptor elements, the wicking element occupying the space and the reservoir being positioned outside the space, and the first and the second susceptor elements being fluid permeable.

The present disclosure relates to an electrically heated aerosol-generating system, a cartridge for use in an electrically heated aerosol-generating system and a susceptor assembly for an electrically heated aerosol-generating system.

In many known aerosol-generating systems, an aerosol-forming substrate is heated and vaporised to form a vapour. The vapour cools and condenses to form an aerosol. In some aerosol-generating systems, such as electrically heated smoking systems, this aerosol is then inhaled by a user. Such electrically heated smoking systems are typically handheld and comprise a power supply, a storage portion for holding a supply of the aerosol-forming substrate and a heater element. The aerosol-forming substrate may be a liquid. In such cases, the aerosol-generating system may further comprise a wicking element configured to draw liquid aerosol-forming substrate from the storage portion to the heater element to be heated.

Some aerosol-generating systems comprise an aerosol-generating device and a cartridge that is configured to be used with the device. In such systems, the aerosol-generating device is typically designed to be reusable and comprises the power supply. The cartridge is designed to be disposable and comprises or forms the storage portion holding the aerosol-forming substrate. Once the aerosol-forming substrate is depleted, the cartridge is replaced. The heater element may be located in the cartridge.

Handheld aerosol-generating systems comprising an inductive heating system have been proposed. Inductive heating systems typically comprise at least one inductor coil connected to the power supply and a susceptor element arranged in close proximity to the aerosol-forming substrate and within the alternating magnetic field. When the aerosol-generating system comprises an aerosol-generating device and a cartridge, the susceptor element may form part of the cartridge or the device.

The power supply is configured to supply an alternating current to the inductor coil, which generates and alternating magnetic field that induces a current to flow in the susceptor element. When the susceptor element is penetrated by the alternating magnetic field, the susceptor element is heated by at least one of Joule heating from induced eddy currents in the susceptor and hysteresis losses. The heated susceptor element heats the aerosol-forming substrate causing volatile compounds to be released from the aerosol-forming substrate, which cool to form an inhalable aerosol.

One advantage of inductive heating systems is that the electrical components of the system can be isolated from the aerosol forming substrate and any generated aerosol. Another advantage is that the construction of the cartridge can be simplified because there is no need to provide electrical connection with the device.

It would be desirable to provide an efficient and robust inductive heating system for generating aerosol and a system in which low frequency alternating current can be used.

According to the present disclosure there is provided an electrically heated aerosol-generating system. The aerosol-generating system may comprise at least one inductor coil. The aerosol-generating system may comprise a power supply. The power supply may be connected to the at least one inductor coil. The power supply may be configured to provide an alternating current to the at least one inductor coil to generate an alternating magnetic field. The aerosol-generating system may comprise a housing containing a reservoir of aerosol-forming substrate. The aerosol-generating system may comprise a substantially planar susceptor assembly. The susceptor assembly may be configured to be heated by the alternating magnetic field. The susceptor assembly may comprise a first susceptor element. The susceptor assembly may comprise a second susceptor element. The susceptor assembly may comprise a wicking element. The wicking element may be in fluid communication with the reservoir. The first and second susceptor elements may be integral with or fixed to the wicking element. A space may be defined between the first and second susceptor elements. The wicking element may occupy the space.

The reservoir may be positioned outside the space between the first and second susceptor elements. In other words, the susceptor assembly may be arranged substantially outside of the reservoir. In particular, each susceptor element of the susceptor assembly may be arranged substantially outside of the reservoir. Preferably, at least a portion of the major surfaces of the or each susceptor element is not in direct contact with the reservoir. Preferably, at least a portion of two opposing major surfaces of the susceptor assembly is in direct contact with air in an airflow passage in the system.

In operation, an alternating current is passed through the at least one inductor coil to generate an alternating magnetic field that induces a voltage in the first and second susceptor elements. The induced voltage causes a current to flow in each of the first and second susceptor elements and this current causes Joule heating of the first and second susceptor elements that in turn heats the aerosol-forming substrate that has been transported by the wicking element. If the susceptor element is ferromagnetic, hysteresis losses in the susceptor element may also generate heat.

The aerosol-forming substrate may be a liquid. The reservoir may be configured to hold the liquid aerosol-forming substrate. The reservoir may have any suitable shape and size depending on the requirements of the aerosol-generating system.

In some embodiments, the reservoir contains a retention material for holding a liquid aerosol-forming substrate. Where the reservoir comprises a plurality of portions, the retention material may be positioned in one or more of the portions of the reservoir, or in all of the portions of the reservoir. The retention material may be a foam material, a sponge material or a collection of fibres. The retention material may be formed from a polymer or co-polymer. In one embodiment, the retention material is a spun polymer. The retention material may be formed from any of the materials described below as suitable for the wicking element.

When the reservoir comprises a retention material, the wicking element may be in fluid communication with the retention material. The retention material may contact the susceptor assembly. In particular, the retention material may be in contact with a wicking element of the susceptor assembly.

As the wicking element is in fluid communication with the reservoir it may advantageously transport liquid aerosol-forming substrate from the reservoir. As such, a proportion of the aerosol-forming substrate may be transported towards the first and second susceptor elements. The transport of the aerosol-forming substrate may be a result of capillary action in the wicking element. In particular, the wicking element may be arranged to convey aerosol-forming substrate from the reservoir across a major surface of the first and second susceptor elements that are fixed to or integral with the wicking element.

The provision of a wicking element improves the wetting of the first and second susceptor elements and so increases aerosol generation by the system. It allows the susceptor elements to be made from materials that do not themselves provide good wicking or wetting performance.

Providing the wicking element between the first and second susceptor elements that are integral with or fixed to the wicking elements may, in operation, advantageously result in aerosol-forming substrate being vaporised at the outer surfaces of the wicking element, closest to the susceptor elements. Therefore, the generated vapour may primarily be generated on the interface between the susceptor elements and the wicking element. The generated vapour may thus not need to pass through the bulk of the wicking element to escape the wicking element which could result in cooling and possible condensing of the vapour. This arrangement may advantageously promote more immediate production of aerosol following the provision of an alternating current to the inductor coil and may be more efficient and consume less power.

The wicking element occupying a space between the first and second susceptor elements may advantageously mean that, in operation, the wicking element is heated from two opposing sides. This may increase the amount aerosol-forming substrate that is vaporised in a given time compared to a susceptor assembly comprising only one susceptor element.

Advantageously the susceptor assembly may be configured to hold only a small volume of liquid aerosol-forming substrate, sufficient for a single user puff. This is advantageous because it allows that small volume of liquid to be vaporised rapidly, with minimal heat loss to other elements of the system or to liquid aerosol-forming substrate that is not vaporised. Advantageously, the susceptor assembly, or a heating region of the susceptor assembly, may hold between 2 and 10 millilitres of liquid aerosol-forming substrate.

The reservoir may be configured to hold at least twice as much aerosol-forming substrate as the susceptor assembly. Preferably, the reservoir may be configured to hold at least 5, 10, 15 or even 20 times as much aerosol-forming substrate as the susceptor assembly.

The reservoir may be configured to hold enough aerosol-forming substrate for at least 10 puffs, preferably at least 20 puffs, even more preferably at least 30 puffs. The reservoir may be configured to hold enough aerosol-forming substrate for at least 2 smoking sessions, preferably at least 3, 4, 5 or 6 smoking sessions. Each smoking session may comprise at least 4 puffs, preferably at least 5 puffs, even preferably at least 6 puffs. This contrasts with the susceptor assembly which, as above, may be configured to hold only enough liquid aerosol-forming substrate for a single user puff at any one time.

The first and second susceptor element may be fluid permeable. As used herein, a “fluid permeable” element means an element that allows liquid or gas to permeate through it. A fluid permeable susceptor element may advantageously allow vaporised aerosol-forming substrate to escape through the susceptor element. Therefore, the aerosol-forming substrate vapour generated in the region of the wicking element immediately adjacent to the susceptor element may escape through the susceptor element without needing to pass through the wicking element.

As used herein, a “susceptor element” means an element that is heatable by penetration with an alternating magnetic field. A susceptor element is typically heatable by at least one of Joule heating through induction of eddy currents in the susceptor element, and hysteresis losses. Possible materials for the susceptor elements include graphite, molybdenum, silicon carbide, stainless steels, niobium, aluminium and virtually any other conductive elements. Advantageously the first and second susceptor elements may be ferrite elements. The material and the geometry for the susceptor elements can be chosen to provide a desired electrical resistance and heat generation. Preferably, the first and second susceptor element comprises AISI 430 stainless steel.

Advantageously, the first and second susceptor elements may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating.

As used herein, an “alternating current” means a current that periodically reverses direction. Driving an alternating current through the at least one inductor coil causes the at least one inductor coil to generate an alternating magnetic field. The alternating magnetic field may have any suitable frequency for heating a heating region of a susceptor element located in the alternating magnetic field. Suitable frequencies for the alternating current may be between 100 kilohertz (kHz) and 30 megahertz (MHz). The alternating current may have a frequency of between 100 kilohertz (kHz), and 1 megahertz (MHz).

The thickness of each of the susceptor elements is advantageously of a similar order to the skin depth of the material of the susceptor element at the frequency of operation of the system. Advantageously the susceptor assembly has a thickness of no greater than ten times the skin depth of the material of the susceptor element at the frequency of operation. This may ensure that each of susceptor elements has a suitably low mass and so the time taken for the susceptor elements to reach a temperature suitable for volatizing the aerosol-forming substrate is low. When the susceptor element is penetrated by alternating magnetic fields from opposing sides, each susceptor element may advantageously have a thickness of at least twice the skin depth of the material of susceptor element at the frequency of operation. This may minimize the interaction of the skin effects on opposing sides of the susceptor element.

Each susceptor element may have a thickness of no more than two millimetres. Preferably, each susceptor element may have a thickness of one millimetre.

The first and second susceptor elements may comprise or consist of electrically conductive filaments. The first and second susceptor elements may comprise or consist of a mesh, flat spiral coil, fibres or fabric of the electrically conductive filaments. As used herein the term “mesh” encompasses grids and arrays of filaments having spaces therebetween. The term mesh also includes woven and non-woven fabrics. In operation, vaporised aerosol-forming substrate may advantageously escape from the wicking element through interstices between the electrically conductive filaments.

While it may be the wicking element that transports the aerosol-forming substrate from the reservoir to the first and second susceptor elements by capillary action, the electrically conductive filaments may also give rise to capillary action in the interstices between the filaments of the mesh to wet the first and second susceptor elements. The wetting of the first and second susceptor elements may advantageously increase the contact area between the electrically conductive filaments of the susceptor element and the aerosol-forming substrate.

The electrically conductive filaments may have a diameter of between 40 micrometres and 60 micrometres, preferably between 45 and 55 micrometres and even more preferably 50 micrometres. The mesh aperture of a mesh of the electrically conductive filaments may be between 60 and 150 micrometres, preferably between 50 to 70 micrometres, even more preferably between 60 and 65 micrometres and most preferably 63 micrometres. These dimensions may be suitable for providing capillary action within the first and second susceptor elements.

The percentage of open area of the mesh, which is the ratio of the area of the interstices to the total area of the mesh is preferably between 25 percent and 56 percent. The mesh may be formed using different types of weave or lattice structures. Alternatively, the filaments consist of an array of filaments arranged parallel to one another.

The filaments may be formed by etching a sheet material, such as a foil. This may be particularly advantageous when the heater assembly comprises an array of parallel filaments. If the heating element comprises a mesh or fabric of filaments, the filaments may be individually formed and knitted together.

Preferably, the mesh is sintered. Advantageously, sintering the mesh creates electrical bonds between filaments extending in different directions. In particular, where the mesh comprises one or more of woven and non-woven fabrics, it is advantageous for the mesh to be sintered to create electrical bonds between overlapping filaments.

Alternatively, the first and second susceptor elements may comprise or consist of a perforated foil. In operation, vaporised aerosol-forming substrate may advantageously escape from the wicking element through the perforations of the perforated foil. The perforations may be uniformly distributed across the first and second susceptor elements. Each susceptor element may be perforated to allow for the egress of vapour from the susceptor assembly or to allow for the ingress of liquid aerosol-forming substrate.

Alternatively, each susceptor element may be printed or otherwise deposited on the wicking element, as a film or plurality of tracks. Each susceptor element may comprise or consist of an electrically conductive material deposited directly onto the wicking element. The electrically conductive material of the first or second susceptor element may be deposited on to the wicking element as a plurality of tracks. In operation, vaporised aerosol-forming substrate may advantageously escape from the wicking element through gaps or spaces between the tracks. The plurality of tracks of each of the susceptor elements may advantageously be distributed over a surface of the wicking element to provide substantially uniform heating across that surface. For example, the width of each of the tracks and the spacing between the tracks may be substantially the same for each of the plurality of tracks. The plurality of tracks of each of the susceptor elements may comprise a first set of tracks parallel to one another. The plurality of tracks may further comprise a second set of tracks perpendicular to the first set of tracks and overlapping the first set of tracks. The first and second sets of tracks may together form a mesh-like structure.

The wicking element may comprise a capillary material. A capillary material is a material that is capable of transport of liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid aerosol-forming substrate across a major surface of each of the susceptor elements. In some embodiments, the capillary material may comprise sponge-like or foam-like material. The structure of the capillary material may form a plurality of small bores or tubes, through which the liquid aerosol-forming substrate can be transported by capillary action. Where the susceptor elements comprise interstices or apertures, the capillary material may extend into interstices or apertures in the susceptor element. The susceptor elements may draw liquid aerosol-forming substrate into the interstices or apertures by capillary action. The wicking element may comprise or consist of an electrically insulating material. The wicking element may comprise a non-metallic material. The wicking element may comprise a hydrophilic material or an oleophilic material. This may advantageously encourage the transport of the aerosol-forming substrate through the wicking element.

The wicking element may preferably comprise or consist of cotton, rayon or glass fibre.

Alternatively, the wicking element may comprise or consist of a porous ceramic material. Wicking elements comprising porous ceramic materials may be particularly advantageous when one or both of the susceptor elements comprise an electrically conductive material printed or otherwise deposited on the wicking element. A wicking element comprising a porous ceramic material may be a suitable substrate for the manufacturing processes associated with the printing or deposition of the electrically conductive material.

The first susceptor element of the susceptor assembly may be electrically isolated from the second susceptor element of the susceptor assembly.

The substantially planar susceptor assembly may extend parallel to a first plane. The aerosol-generating system may comprise a first inductor coil and a second inductor coil, the first inductor coil positioned on a first side of the susceptor assembly and extending parallel to the first plane, the second inductor coil positioned on a second side of the susceptor assembly opposite the first side and extending parallel to the first plane. The susceptor assembly may be positioned between the first inductor coil and the second inductor coil. The aerosol-generating system may comprise control circuitry connected to the first and second inductor coils and configured to provide alternating current to the first and second inductor coils. Advantageously, the susceptor assembly may be substantially equidistant from the first and second inductor coils.

This arrangement may provide for efficient heating of the susceptor elements of the susceptor assembly and allows for a balance of forces exerted on the susceptor assembly by the magnetic fields generated by the first and second inductor coils. Advantageously, the control circuitry is configured to provide current to the inductor coils so that the first inductor coil provides equal and opposite force on the susceptor assembly to the second inductor coil. The first inductor coil may generate a magnetic field that is opposite to a magnetic field generated by the second inductor coil.

In this context a planar susceptor element is a susceptor element having a substantially greater length and width than thickness. The ratio of the length to the width may be between 0.4 and 1.6. Preferably, the ratio of the length to the width may be between 0.6 and 1.4. Even more preferably, the ratio of the length to the width may be between 0.8 and 1.2.

The length and width directions are orthogonal to one another and define the first plane. The thickness extends orthogonal to the first plane. A planar susceptor element may have two opposing major surfaces extending in plane parallel to the first plane. One or both major surfaces is advantageously flat.

In this context, the susceptor assembly being substantially equidistant form the first and second inductor coils means that the shortest distance between the first inductor coil and the susceptor assembly is between 0.8 and 1.2 times the shortest distance between the second inductor coil and the susceptor assembly. Preferably the shortest distance between the first inductor coil and the susceptor assembly is between 0.85 and 1.15 times the shortest distance between the second inductor coil and the susceptor assembly. More preferably, the shortest distance between the first inductor coil and the susceptor assembly is between 0.9 and 1.1 times the shortest distance between the second inductor coil and the susceptor assembly. Even more preferably, the shortest distance between the first inductor coil and the susceptor assembly is substantially identical to the shortest distance between the second inductor coil and the susceptor assembly.

Advantageously, the first and second inductor coils are planar inductor coils. In this context a planar inductor coil means a coil that lies in a plane normal to the axis of winding of the coil. Planar inductor coils may be compact. The planar inductor coils may each lie in plane parallel to the first plane.

The system may be configured so that the at least one inductor coil provides a magnetic field at the susceptor assembly that is normal to the first plane. The system may be configured so that the first and second inductor coils provide a magnetic field at the susceptor assembly that is normal to the first plane. This allows for efficient heating of the susceptor element. It has also been found by the inventors that such an arrangement promotes efficient heating of the first and second susceptor elements such that lower frequencies of alternating of current can be used. For example, an alternating current having a frequency of between 100 kHz and 1 MHz may be used. Lower frequencies may allow for simpler electronics to be used to supply the alternating current.

The first and second planar inductor coils may have any shape, but in one advantageous embodiment each of the planar inductor coils is rectangular. The planar inductor coils may advantageously have a size and shape corresponding to a heating area of the susceptor element. The first inductor coil may have the same number of turns as the second inductor coil. The first inductor coil may have the same size and shape as the second inductor coil. The first inductor coil may be substantially identical to the second inductor coil. The first inductor coil may have an identical electrical resistance to the second inductor coil. The first inductor coil may have an identical inductance to the second inductor coil.

In one embodiment, the inductor coils are electrically connected to form a single conductive path, and wherein the first inductor coil is wound in an opposite sense to the second inductor coil. The first and second inductor coils may then be provided with an identical alternating electrical current.

In another embodiment, the first inductor coil is wound in the same sense to the second inductor coil. The control circuitry is configured to provide current to the first inductor coil that is directly out of phase with the current provided to the second inductor coil.

Advantageously, the aerosol-generating system may comprise one or more flux concentrators configured to contain a magnetic field generated by the inductor coils. The one or more flux concentrators may be configured to concentrate the magnetic field on the susceptor assembly, preferably perpendicular to the first plane.

Each susceptor element of the susceptor assembly may comprise a heating region and at least one mounting region. The first and second susceptor elements may have the same shape as one another. The heating region and at least one mounting region of the first susceptor element may correspond to the heating region and at least one mounting region of the second susceptor element. Features of the heating region or at least one mounting region described in relation to one of the first and second susceptor elements may apply equally to the other of the first and second susceptor elements.

The heating region may be a region of the susceptor element that is configured to be heated to a temperature required to vapourise the aerosol-forming substrate upon penetration by a suitable alternating magnetic field.

The heating region may comprise a first material that is a magnetic material heatable by penetration with an alternating magnetic field. The term “magnetic material” is used herein to describe a material which is able to interact with a magnetic field, including both paramagnetic and ferromagnetic materials. The first material may be any suitable magnetic material that is heatable by penetration with an alternating magnetic field. In some preferred embodiments, the first material comprises a ferritic stainless steel. Suitable ferritic stainless steels include AISI 400 series stainless steels, such as AISI type 409, 410, 420 and 430 stainless steels.

In some preferred embodiments, the heating region consists of the first material. However, in other embodiments, the heating region comprises the first material and one or more other materials. Where the heating region comprises the first material and one or more other materials, the heating region may comprise any suitable proportion of the first material. For example, the heating region may comprise at least 10 percent by weight of the first material, or at least 20 percent by weight of the first material, or at least 30 percent by weight of the first material, or at least 40 percent by weight of the first material, or at least 50 percent by weight of the first material, or at least 60 percent by weight of the first material, or at least 70 percent by weight of the first material, or at least 80 percent by weight of the first material, or at least 90 percent by weight of the first material.

The at least one mounting region of the each of susceptor elements is a region that is configured to contact a susceptor assembly holder. The at least one mounting region may be in contact with a susceptor assembly holder. As used herein, the term “contact” means both direct contact and indirect contact. The heating region may be configured to heat to a substantially higher temperature than the mounting region in the presence of an alternating magnetic field. This may be due to material differences between the heating region and the mounting region, geometric differences between the heating region and the mounting region, or both material and geometric differences. The heating region may be located in a space directly between the first and second inductor coils and the mounting region may be located outside the space directly between the first and second inductor coils. The mounting region may have a smaller width or length in the first plane than the heating region.

Preferably, the at least one mounting region is in direct contact with the susceptor assembly holder. As used herein, the term ‘direct contact’ means contact between two components without any intermediate material, such that the surfaces of the two components are touching each other.

The at least one mounting region of each susceptor element may be in indirect contact with the susceptor assembly holder. As used herein, the term ‘indirect contact’ is used to mean contact between two components via one or more intermediate materials interposed between the two components, such that the surfaces of the two components are not touching each other. For example, the at least one mounting region of each susceptor element is in indirect contact with the susceptor assembly holder when an element of adhesive is provided between a surface of the at least one mounting region and a surface of the susceptor assembly holder.

In some preferred embodiments, the at least one mounting region may extend into the reservoir. In some preferred embodiments, the heating region of each of the susceptor elements may be arranged outside of the reservoir. Advantageously, arranging each of the susceptor elements substantially outside of the reservoir, and particularly arranging the heating region of each of the susceptor elements outside of the reservoir, may ensure that the aerosol-forming substrate is heated sufficiently to release the volatile compounds only after the aerosol-forming substrate has been transported outside of the reservoir. This may facilitate release of the volatile compounds from the aerosol-generating system.

The at least one mounting region of each of the susceptor elements may comprise a second material. The second material may be a non-magnetic material. The term “non-magnetic material” is used herein to describe a material which does not interact with a magnetic field, and is not heatable by penetration with an alternating magnetic field. The second material may be any suitable non-magnetic material. In some embodiments, the second material is a non-magnetic metal. For example, the second material may be a non-magnetic austenitic stainless steel. Suitable austenitic stainless steels include AISI 300 series stainless steels, such as AISI type 304, 309 and 316 stainless steels.

The susceptor assembly holder may be in contact with the second material at the at least one mounting region of each of the susceptor elements. The susceptor assembly holder may contact each susceptor element at the second material only. Advantageously, providing contact between the susceptor assembly holder and the susceptor element at the second material may help to minimise heat transfer from the susceptor element to the susceptor assembly holder.

In some embodiments, the second material is non-metallic. For example, the second material may be a ceramic material.

In some embodiments, the second material is an electrically conductive material. As used herein, an “electrically conductive” material means a material having a volume resistivity at 20 degrees Celsius (° C.) of less than about 1×10⁻⁵ ohm-metres (Ωm), typically between about 1×10⁻⁵ ohm-metres (Ωm) and about 1×10⁻⁹ ohm-metres (Ωm). Suitable electrically conductive materials include metals, alloys, electrically conductive ceramics and electrically conductive polymers. Suitable electrically conductive materials may include gold and platinum.

In some embodiments, the second material is an electrically insulative material. Advantageously an electrically insulative second material may help to minimise heat transfer from each of the susceptor elements to the susceptor assembly holder. As used herein, an “electrically insulating” material means a material having a volume resistivity at 20 degrees Celsius (° C.) of greater than about 1×10⁶ ohm-metres (Ωm), typically between about 1×10⁹ ohm-metres (Ωm) and about 1×10²¹ ohm-metres (Ωm). Suitable electrically insulating materials include glasses, plastics and certain ceramic materials.

In some embodiments, the second material is a thermally insulative material. Advantageously a thermally insulative second material may help to minimise heat transfer from each of the susceptor elements to the susceptor assembly holder. As used herein, the term “thermally insulative” refers to a material having a bulk thermal conductivity of less than about 5 Watts per metre Kelvin (mW/(m K)) at 23° C. and a relative humidity of 50% as measured using the modified transient plane source (MTPS) method.

In some embodiments, the second material is a thermally conductive material. As used herein, the term “thermally conductive” refers to a material having a bulk thermal conductivity of at least about 10 Watts per metre Kelvin (mW/(m K)) at 23° C. and a relative humidity of 50% as measured using the modified transient plane source (MTPS) method.

In some embodiments, the second material may be a hydrophilic material. In some embodiments, the second material may be an oleophilic material. Advantageously, providing a hydrophilic second material or an oleophilic second material may encourage the transport of the aerosol-forming substrate through each of the susceptor elements.

In some embodiments, the second material comprises a cellulosic material. For example, the second material may comprises rayon.

In some preferred embodiments, the at least one mounting region of each of the susceptor elements consists of the second material. However, in other embodiments, the at least one mounting region comprises the second material and one or more other materials. Where the at least one mounting region comprises the second material and one or more other materials, the at least one mounting region may comprise any suitable proportion of the second material. For example, the at least one mounting region of the susceptor element may comprise: at least 10 percent by weight of the second material, or at least 20 percent by weight of the second material, or at least 30 percent by weight of the second material, or at least 40 percent by weight of the second material, or at least 50 percent by weight of the second material, or at least 60 percent by weight of the second material, or at least 70 percent by weight of the second material, or at least 80 percent by weight of the second material, or at least 90 percent by weight of the second material.

The at least one mounting region of each susceptor element may comprise the first material. However, the at least one mounting region comprises a lower proportion of the first material than the heating region. The proportion by weight of the first material in the heating region may be greater than the proportion by weight of the first material in the at least one mounting region. For example: the heating region of the susceptor element may comprise at least 90 percent by weight of the first material, and the at least one mounting region of the susceptor element may comprise less than 10 percent by weight of the first material, or the heating region of the susceptor element may comprise at least 80 percent by weight of the first material, and the at least one mounting region of the susceptor element may comprise less than 20 percent by weight of the first material, or the heating region of the susceptor element may comprise at least 70 percent by weight of the first material, and the at least one mounting region of the susceptor element may comprise less than 30 percent by weight of the first material, or the heating region of the susceptor element may comprise at least 60 percent by weight of the first material, and the at least one mounting region of the susceptor element may comprise less than 40 percent by weight of the first material, or the heating region of the susceptor element may comprise at least 50 percent by weight of the first material, and the at least one mounting region of the susceptor element may comprise less than 50 percent by weight of the first material.

The at least one mounting region of each of the susceptor elements may comprise: 90 percent or less by weight of the first material, or 80 percent or less by weight of the first material, or 70 percent or less by weight of the first material, or 60 percent or less by weight of the first material, or 50 percent or less by weight of the first material, or 40 percent or less by weight of the first material, or 30 percent or less by weight of the first material, or 20 percent or less by weight of the first material, or 10 percent or less by weight of the first material.

The at least one mounting region of each of the susceptor elements may comprise: at least 10 percent by weight of the second material, and less than 90 percent by weight of the first material, or at least 20 percent by weight of the second material, and less than 80 percent by weight of the first material, or at least 30 percent by weight of the second material, and less than 70 percent by weight of the first material, or at least 40 percent by weight of the second material, and less than 60 percent by weight of the first material, or at least 50 percent by weight of the second material, and less than 50 percent by weight of the first material, or at least 60 percent by weight of the second material, and less than 40 percent by weight of the first material, or at least 70 percent by weight of the second material, and less than 30 percent by weight of the first material, or at least 80 percent by weight of the second material, and less than 20 percent by weight of the first material, or at least 90 percent by weight of the second material, and less than 10 percent by weight of the first material.

The heating region of each of the susceptor elements may comprise the second material. For example, the heating region may comprise: 90 percent or less by weight of the second material, or 80 percent or less by weight of the second material, or 70 percent or less by weight of the second material, or 60 percent or less by weight of the second material, or 50 percent or less by weight of the second material, or 40 percent or less by weight of the second material, or 30 percent or less by weight of the second material, or 20 percent or less by weight of the second material, or 10 percent or less by weight of the second material.

The heating region of each of the susceptor elements may comprise: at least 10 percent by weight of the first material, and less than 90 percent by weight of the second material, or at least 20 percent by weight of the first material, and less than 80 percent by weight of the second material, or at least 30 percent by weight of the first material, and less than 70 percent by weight of the second material, or at least 40 percent by weight of the first material, and less than 60 percent by weight of the second material, or at least 50 percent by weight of the first material, and less than 50 percent by weight of the second material, or at least 60 percent by weight of the first material, and less than 40 percent by weight of the second material, or at least 70 percent by weight of the first material, and less than 30 percent by weight of the second material, or at least 80 percent by weight of the first material, and less than 20 percent by weight of the second material, or at least 90 percent by weight of the first material, and less than 10 percent by weight of the second material.

The heating region may comprise any suitable proportion of the susceptor element. For example, the heating region may comprise at least 90 percent of the surface area of the susceptor element, at least 80 percent of the surface area of the susceptor element, or at least 70 percent of the surface area of the susceptor element. The heating region may have any suitable size and shape for heating aerosol-forming substrate at the required rate to generate the desired amount of inhalable aerosol.

The at least one mounting region may comprise any suitable proportion of the susceptor element. Typically the at least one mounting region comprises a smaller proportion of the susceptor element than the heating region. For example, the at least one mounting region may comprise 10 percent or less of the surface area of the susceptor element, or 20 percent or less of the surface area of the susceptor element, or 30 percent or less of the surface area of the susceptor element. The at least one mounting region may have any suitable size and shape for providing a robust connection between the susceptor element and the susceptor assembly holder.

In some embodiments, the at least one mounting region is located adjacent a periphery of the heating region, wherein the heating region has a length and a width, and the at least one mounting region has a length and a width. Preferably, the length of the at least one mounting region is less than the length of the heating region. In some embodiments, the length of the at least one mounting region is no more than half of the length of the heating region. In some embodiments, the length of the at least one mounting region is no more than a quarter of the length of the heating region. Preferably, the width of the at least one mounting region is less than the width of the heating region. In some embodiments, the width of the at least one mounting region is no more than half of the width of the heating region. In some embodiments, the width of the at least one mounting region is no more than a quarter of the width of the heating region.

In some embodiments, the at least one mounting region of each of the susceptor elements is fixed to a susceptor assembly holder. The at least one mounting region may be fixed to a susceptor assembly holder by an adhesive.

The at least one mounting region of each of the susceptor elements may be arranged at any suitable position relative to the heating region of each of the susceptor elements. In some preferred embodiments, the at least one mounting region of each of the susceptor elements is at a periphery of the respective susceptor element. For example, the at least one mounting region may be located at one side of the susceptor element.

In some preferred embodiments, the at least one mounting region comprises a plurality of mounting regions. Each susceptor element may comprise any suitable number of mounting regions. For example, each susceptor element may comprise one, two, three, four, five, or six mounting regions. Advantageously, providing the susceptor element with a plurality of mounting regions may enable the susceptor assembly holder to provide more robust support to the susceptor assembly compared to a susceptor element having a single mounting region.

In some embodiments, the plurality of mounting regions may comprise a first mounting region, and a second mounting region, the first mounting region being positioned at one side of the respective susceptor element, and the second mounting region being positioned at the same side of the susceptor element as the first mounting region. In some of these embodiments, the first mounting region is positioned at a first end of the susceptor element, and the second mounting region is positioned at a second end of the susceptor element, opposite the first end.

In some embodiments, the plurality of mounting regions comprises a first mounting region and a second mounting region, the first mounting region being positioned at a first side of the susceptor element, and the second mounting region being positioned at a second side of the susceptor element, opposite to the first side. In some of these embodiments, the heating region has a length, and the first mounting region and the second mounting region are positioned at the same position along the length of the heating region. In some of these embodiments, the first mounting region and the second mounting region are positioned at one end of the susceptor element. In some of these embodiments, the heating region has a length, and the first mounting region and the second mounting region are positioned centrally along the length of the heating region. In some of these embodiments, the heating region has a length, and the first mounting region and the second mounting region are positioned at different positions along the length of the heating region. In some of these embodiments, the first mounting region is positioned at a first end of the susceptor element, and the second mounting region is positioned at a second end of the susceptor element, opposite to the first end.

In some preferred embodiments, the plurality of mounting regions comprises a first mounting region and a second mounting region, the second mounting region being positioned opposite the first mounting region.

In some preferred embodiments, the plurality of mounting regions comprises: a first pair of mounting regions positioned at a first end of the susceptor element, at opposite sides of the susceptor element; and a second pair of mounting regions positioned at a second end of the susceptor element at opposite sides of the susceptor element, the second end of the susceptor element being opposite the first end.

In some embodiments, the plurality of mounting regions comprises a plurality of pairs of mounting regions, each pair of mounting regions including a first mounting region positioned at a first side of the susceptor element, and a second mounting region positioned at a second side of the susceptor element, the second side of the susceptor element being opposite the first side of the susceptor element.

In some embodiments, the plurality of mounting regions comprises a plurality of pairs of mounting regions, each pair of mounting regions including a first mounting region and a second mounting region, the second mounting region being positioned opposite the first mounting region.

Where the susceptor element comprises a mesh, the heating region may comprise filaments of the first material. In some embodiments, the heating region may comprise filaments of the first material and filaments of the second material. The heating region may comprise filaments of the first material in a first direction, and filaments of the second material in a second direction, different to the first direction.

Where the susceptor element comprises a mesh, the at least one mounting region may comprise filaments of the second material. In some embodiments, the at least one mounting region may comprise filaments of the first material and filaments of the second material. The at least one mounting region may comprise filaments of the first material in a first direction, and filaments of the second material in a second direction, different to the first direction.

Where the susceptor element comprises a mesh, the mesh may be woven. A woven mesh comprises filaments in a weft direction, and filaments in a warp direction.

Where the susceptor element comprises a woven mesh, at least one mounting region may comprise filaments of the second material in a weft direction. The susceptor assembly holder may be in contact with the susceptor element at the at least one mounting region at filaments extending in the weft direction. The susceptor assembly holder may be in contact with the susceptor element at the at least one mounting region at filaments extending in the weft direction only, and not in contact with filaments extending in the warp direction. Advantageously, forming the filaments that extend in the weft direction from the second material at the at least one mounting region may reduce heat transfer from the susceptor element to the susceptor assembly holder compared to a susceptor element having filaments in the weft direction formed from the first material at the at least one mounting region.

Where the susceptor element comprises a woven mesh, the at least one mounting region may comprise filaments of the first material in a weft direction, and filaments of the second material in a warp direction, and the at least one mounting region may comprise filaments of the second material in the weft direction and filaments of the second material in the warp direction.

Where the susceptor element comprises a woven mesh, the at least one mounting region may consist of filaments of the first material in a weft direction, and filaments of the second material in a warp direction, and the at least one mounting region may consist of filaments of the second material in the weft direction and filaments of the second material in the warp direction.

Where the susceptor elements each comprise a woven mesh, the at least one mounting region may comprise filaments of the first material in a warp direction, and filaments of the second material in a weft direction, and the at least one mounting region may comprise filaments of the second material in the warp direction and filaments of the second material in the weft direction.

Where the susceptor elements each comprise a woven mesh, the at least one mounting region may consist of filaments of the first material in a warp direction, and filaments of the second material in a weft direction, and the at least one mounting region may consist of filaments of the second material in the warp direction and filaments of the second material in the weft direction.

Where the susceptor elements each comprise a woven mesh, the at least one mounting region may comprise filaments of the first material in a weft direction, and filaments of the first material in a warp direction, and the at least one mounting region may comprise filaments of the first material in the weft direction and filaments of the second material in the warp direction.

Where the susceptor elements each comprise a woven mesh, the at least one mounting region may consist of filaments of the first material in a weft direction, and filaments of the first material in a warp direction, and the at least one mounting region may consist of filaments of the first material in the weft direction and filaments of the second material in the warp direction.

Where the susceptor elements each comprise a woven mesh, the at least one mounting region may comprise filaments of the first material in a warp direction, and filaments of the first material in a weft direction, and the at least one mounting region may comprise filaments of the first material in the warp direction and filaments of the second material in the weft direction.

Where the susceptor elements each comprise a woven mesh, the at least one mounting region may consist of filaments of the first material in a warp direction, and filaments of the first material in a weft direction, and the at least one mounting region may consist of filaments of the first material in the warp direction and filaments of the second material in the weft direction.

Advantageously, the aerosol-generating system may further comprises an airflow passage extending between an air inlet and an air outlet. The air outlet may be defined in a mouthpiece of the system. In operation, a user of the system may inhale on the mouthpiece.

A portion of the susceptor assembly may be within the airflow passage. The airflow in the airflow passage may pass over a surface of the first susceptor element and a surface of the second susceptor element. The airflow in the airflow passage may pass over the heating region of the first and second susceptor elements. Thus, in operation, aerosol-forming substrate that has been vaporised at the interface between the first and second susceptor elements and the wicking element may advantageously pass through the first and second susceptor elements directly into the airflow passage. The vapour may condense to form an aerosol within the airflow passage. The aerosol may be drawn out of the aerosol-generating system through the air outlet. The air outlet may be provided in a mouth end of the aerosol-generating system, through which generated aerosol can be drawn by a user.

The wicking element may be in fluid communication with the reservoir because a portion of the wicking element protrudes into the reservoir. The reservoir may comprise a fluid channel extending towards the susceptor assembly. Liquid aerosol-forming substrate may flow in this channel to the susceptor assembly. At least a portion of the wicking element may protrude into the channel. As described above, the at least one mounting region of each of the susceptor elements may extend into the reservoir.

The housing may comprise an inner wall and an outer wall such that an internal passage is defined by the inner wall. The internal passage may be surrounded by a space defined between the inner wall and outer wall. The space surrounding the internal passage may be an annular space.

The airflow channel may be at least partially defined by the internal passage. The reservoir may be at least partially defined by the space surrounding the internal passage. In this arrangement, at least a portion of the airflow passage may pass through the reservoir.

Alternatively, the reservoir may be at least partially defined by the internal passage and the airflow passage may be at least partially defined by the space surrounding the internal passage.

Having the internal passage at least partially define one of the air flow channel or reservoir and the space surrounding the internal passage at least partially define the other advantageously provides a compact aerosol-generating system. It also allows the system to be made symmetrical and balanced, which is advantageous when the system is a handheld system. Furthermore, these arrangements result in the air flow channel being in close proximity to the reservoir, such that the reservoir may advantageously have a cooling effect on the air in the air flow channel, which may promote the formation of an aerosol in the airflow passage.

As described above, the aerosol-generating system may comprise a susceptor assembly holder onto which the susceptor assembly is mounted. The at least one mounting region of the first and second susceptor elements may contact the holder. The susceptor assembly holder may be tubular having at least one sidewall. The susceptor assembly may be mounted by at least one opening through the sidewall. The susceptor assembly may be mounted by at least two openings through the sidewall.

The susceptor assembly holder may be configured to withstand the temperatures to which the susceptor assembly is raised for heating of the aerosol-forming substrate.

The susceptor assembly holder may be formed from any suitable materials that can withstand the temperatures to which the susceptor is raised for heating of the aerosol-forming substrate. Preferably, the susceptor assembly holder comprises a thermally insulative material. Advantageously, forming the susceptor assembly holder from a thermally insulative material may minimise heat transfer from the susceptor element to the susceptor assembly holder. Preferably, the susceptor assembly holder comprises an electrically insulative material. The susceptor assembly holder may be formed from a durable material. The susceptor assembly holder may be formed from a liquid impermeable material. The susceptor holder may be formed form a mouldable plastics material, such as polypropylene (PP) or polyethylene terephthalate (PET).

The susceptor holder may have any suitable shape and size.

The at least one sidewall of the susceptor assembly holder may form at least part of an inner wall of the housing. In that case, the at least one sidewall of the housing may define part of the internal passage. The space between the inner wall and outer wall may be at least partially defined between the at least one sidewall and the outer wall of the housing. In some preferred embodiments, the susceptor assembly holder is tubular.

In some embodiments, the susceptor assembly extends into the internal passage of the susceptor holder. In some preferred embodiments, the first and second susceptor elements extend into the internal passage of the susceptor holder. The first and second susceptor elements may extend across the internal passage of the susceptor assembly holder. Where the first and second susceptor elements extend across the internal passage of the susceptor holder, the first and second susceptor elements may comprise a first mounting region at a first side of each of the susceptor elements in contact with the susceptor holder, and a second mounting region at a second side of each of the susceptor elements, opposite the first side, in contact with the susceptor holder. Advantageously, arranging the susceptor element to contact the susceptor holder at opposite sides may enable the susceptor holder to robustly secure the susceptor element in position in the cartridge.

The internal passage may extend substantially along a longitudinal axis. In some embodiments, the susceptor assembly is substantially planar, and the susceptor assembly extends parallel to the longitudinal axis. In some embodiments, the susceptor assembly is substantially planar and the susceptor assembly extends perpendicular to the longitudinal axis.

In some embodiments, the internal passage of the susceptor assembly holder may form part of an air passage of the cartridge and a space surrounding the internal passage, defined between the susceptor assembly holder and an outer housing of the system may form part of the reservoir. In these embodiments, the heating region of the susceptor element may be arranged in the internal passage of the susceptor holder and the at least one mounting region may be arranged in the space.

In some embodiments, the internal passage of the susceptor assembly holder may form part of the reservoir of the cartridge and a space surrounding the internal passage, defined between the susceptor assembly holder and an outer housing of the system, may form part of the air passage. In these embodiments, the at least one mounting region of the susceptor element may extend into the internal passage of the susceptor holder and the heater region may extend into the space.

The tubular susceptor assembly holder may have an open end, such that the internal passage of the susceptor holder is open at least at one end. The at least one side wall of the tubular susceptor holder may define an opening between the ends of the tubular susceptor holder. The at least one mounting region of the susceptor element may extend into the opening of the tubular susceptor holder. In some embodiments, where the susceptor element comprises a plurality of mounting regions, the at least one side wall of the tubular susceptor holder defines a plurality of openings between the ends of the tubular susceptor holder. In these embodiments, each mounting region of the susceptor element may extend into one of the plurality of openings of the at least one side wall of the tubular susceptor holder.

The susceptor assembly holder may comprise an electrically insulating material. Suitable electrically insulating materials include glasses, plastics and certain ceramic materials.

The susceptor assembly holder may comprise a thermally insulating material.

The susceptor assembly holder may be moulded onto the susceptor assembly. The moulded holder may retain the first and second susceptor elements and the wicking element together such that the elements are fixed together. The holder may be formed of a heat-resistant plastic material or a ceramic material. The holder may therefore support the susceptor assembly and provide strength to the susceptor assembly.

The susceptor assembly may be surrounded by a permeable electrically insulating coating. The coating may comprise or consist of a permeable ceramic material. The coating may be a ceramic coating. When the susceptor assembly comprises a coating, it may be the coating that retains the first and second susceptor elements and the wicking element together such that the elements are fixed together. The coating may advantageously improve the robustness and strength of the susceptor assembly. The provision of a coating may be instead of, or in addition to, a holder as described above. The coating may comprise an Al₂O₃ or silicon based ceramic material. The coating may have a porosity of about 30 percent.

At least a portion of the susceptor assembly holder may comprise a porous or permeable material such as a ceramic material. The portion may be the region of the susceptor assembly to which the mounting region of the susceptor assembly is mounted. Aerosol-forming substrate from the reservoir may pass through this portion of the susceptor assembly holder to the mounting regions of the susceptor assembly. This advantageously provides a route for aerosol-forming substrate to be transported to the susceptor assembly from the reservoir and may increase the amount of aerosol-forming substrate supplied to the susceptor assembly.

The portion of the susceptor assembly holder comprising a porous or permeable material may comprise an Al₂O₃ or silicon based ceramic material. The portion may have a porosity of about 30 percent.

The susceptor assembly may further comprise a third susceptor element and a second wicking element, the second wicking element being positioned between the first susceptor element and the third susceptor element or the second susceptor element and the third susceptor element. There may be further wicking elements between further susceptor elements.

The aerosol-generating system may comprise a second susceptor assembly. The second susceptor assembly may be substantially similar to the first susceptor assembly in terms of structure. The second susceptor assembly may also be mounted on a susceptor assembly holder. The second susceptor assembly may be mounted on the same susceptor assembly holder as the first susceptor assembly. When the susceptor assembly holder is tubular, the second susceptor assembly may be mounted on an opposite side of the susceptor assembly holder to the first susceptor assembly. This arrangement may be particularly advantageous when the internal passage of the susceptor assembly holder forms part of the reservoir of the cartridge and an annular space defined between the susceptor assembly and the outer housing forms at least part of an airflow passage. The at least one mounting region of the susceptor elements of each of the susceptor assemblies may protrude into the internal passage and the heating region may extend into the annular space. Therefore, the heating region of the first and second susceptor assemblies may be evenly spaced out around the airflow channel resulting in more uniform aerosol production.

The aerosol-generating system may comprise further susceptor assemblies. Each of these susceptor assemblies may be mounted on the susceptor assembly holder. The susceptor assemblies may be mounted on the susceptor assembly holder such that they are evenly distributed around the airflow passage.

The aerosol-forming substrate is a substrate capable of releasing volatile compounds that can form an aerosol. The volatile compounds may be released by heating the aerosol-forming substrate.

The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material. The aerosol-forming substrate may comprise homogenised tobacco material. The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol and, most preferred, glycerine. The aerosol-forming substrate may comprise other additives and ingredients, such as flavourants.

The system may further comprise electric circuitry connected to the at least one inductor coil and to an electrical power source. The electric circuitry may comprise a microprocessor, which may be a programmable microprocessor, a microcontroller, or an application specific integrated chip (ASIC) or other electronic circuitry capable of providing control. The electric circuitry may comprise further electronic components. The electric circuitry may be configured to regulate a supply of current to the inductor coil. Current may be supplied to the inductor coil continuously following activation of the system or may be supplied intermittently, such as on a puff by puff basis. The electric circuitry may advantageously comprise DC/AC inverter, which may comprise a Class-D or Class-E power amplifier. The control circuitry may comprise further electronic components. For example, in some embodiments, the control circuitry may comprise any of: sensors, switches, display elements.

The aerosol-generating system may comprise a power source. The power source may be contained in the device of the system. The power source may be a DC power supply. The power source may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power source may be another form of charge storage device such as a capacitor. The power source may be rechargeable and be configured for many cycles of charge and discharge. The power source may have a capacity that allows for the storage of enough energy for one or more user experiences of the aerosol-generating system; for example, the power source may have sufficient capacity to allow for the continuous generation of aerosol for a period of around six minutes, corresponding to the typical time taken to smoke a conventional cigarette, or for a period that is a multiple of six minutes. In another example, the power source may have sufficient capacity to allow for a predetermined number of puffs or discrete activations of the atomiser assembly.

The aerosol-generating system may comprise an aerosol-generating device and a cartridge configured to be used with the device. The aerosol-generating device may comprise the at least one inductor coil, the power supply and a device housing. The device housing may be configured to engage at least a portion of the cartridge when the cartridge is used with the aerosol-generating device. The cartridge may comprise the susceptor assembly. The cartridge may further comprise a cartridge housing. The at least one inductor coil may be positioned around or adjacent the susceptor assembly when the cartridge is engaged with the aerosol-generating device. When the aerosol-generating system comprises a first and second inductor coil, the first inductor coil may be positioned on a first side of the cartridge and the second inductor coil may be positioned on a second side of the cartridge when cartridge is engaged with the aerosol-generating device. The portion of the cartridge comprising the susceptor assembly of the cartridge may be located between the first and second inductor coil when the cartridge is engaged with the aerosol-generating device.

The cartridge housing may comprise the housing defining the reservoir. The cartridge may comprise the holder for the susceptor assembly.

According to the present disclosure there is also provided a cartridge for use in an electrically heated aerosol-generating system that comprises an aerosol-generating device. The cartridge may be configured to be used with the device. The device may comprise a device housing configured to engage at least a portion of the cartridge when the cartridge is used with the aerosol-generating device. The aerosol-generating device may comprise at least one inductor coil. The aerosol-generating device may comprise a power supply connected to the at least one inductor coil. The power supply may be configured to provide an alternating current to the at least one inductor coil so that the inductor coil generates an alternating magnetic field within the cartridge. The cartridge may comprise a cartridge housing. The cartridge housing may define a reservoir containing an aerosol-forming substrate. The cartridge may comprise a substantially planar susceptor assembly. The substantially planar susceptor assembly may extend parallel to a first plane. The susceptor assembly may be configured to be heated by the alternating magnetic field. The susceptor assembly may comprise a first susceptor element. The susceptor assembly may comprise a second susceptor element. The susceptor assembly may comprise a wicking element in fluid communication with the reservoir. The first and second susceptor elements may be integral with or fixed to the wicking element. A space may be defined between the first and second susceptor elements. The wicking element may occupy the space. The reservoir may be positioned outside the space.

The housing of the aerosol-generating device may be elongate. The housing of the aerosol-generating device may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving the cartridge. The aerosol-generating device may comprise one or more air inlets. The one or more air inlets may enable ambient air to be drawn into the cavity.

The aerosol-generating device may have a connection end configured to connect the aerosol-generating device to a cartridge. The connection end may comprise the cavity for receiving the cartridge.

The aerosol-generating device may have a distal end, opposite the connection end. The distal end may comprise an electrical connector configured to connect the aerosol-generating device to an electrical connector of an external power source, for charging the power source of the aerosol-generating device.

The cartridge may comprise an outer housing. The outer housing may be formed from a durable material. The outer housing may be formed from a liquid impermeable material. The outer housing may be formed form a mouldable plastics material, such as polypropylene (PP) or polyethylene terephthalate (PET). The outer housing may be formed from the same material as the susceptor holder or may be formed from a different material.

The susceptor assembly may be arranged in the outer housing. The susceptor assembly holder may be arranged in the outer housing. In some embodiments, the susceptor assembly holder may be integrally formed with the outer housing.

The outer housing of the cartridge may define a portion of the reservoir. The outer housing may define the reservoir. The outer housing and the reservoir may be integrally formed. Alternatively, the reservoir may be formed separately from the outer housing, and arranged in the outer housing.

In some preferred embodiments where the cartridge comprises an outer housing, the susceptor assembly holder may secure the susceptor assembly to the outer housing. Advantageously, providing the cartridge with a susceptor assembly holder that secures the susceptor assembly to the housing may separate the susceptor assembly from the outer housing, such that the outer housing is not required to be configured to withstand the temperatures to which the susceptor assembly is raised for heating of the aerosol-forming substrate. This may enable the cartridge to be made from less durable and less expensive materials.

The cartridge may comprise two portions, a first portion and a second portion. The second portion may be movable relative to the first portion. The first and second portions of the cartridge may be movable relative to each other between a storage configuration and a use configuration. In the storage configuration, the susceptor assembly may be isolated from the aerosol-forming substrate. In the use configuration, the susceptor assembly may be in fluid communication with the aerosol-forming substrate.

The reservoir may comprise two portions, a first portion and a second portion. A seal may be provided between the first portion and the second portion. The seal may be arranged to prevent fluid communication between the first portion of the reservoir and the second portion of the reservoir. In other words, the seal may fluidly isolate the first portion of the reservoir from the second portion of the reservoir. In the storage configuration, the liquid aerosol-forming substrate may be held in the first portion of the reservoir. In the storage configuration, the seal may prevent the aerosol-forming substrate from flowing from the first portion of the reservoir to the second portion of the reservoir.

The first portion of the cartridge may comprise the first portion of the reservoir, and the seal. The second portion of the cartridge may comprise the susceptor holder and the susceptor assembly. The susceptor holder may comprise one or more piercing elements. The one or more piercing elements may be arranged to pierce or penetrate the seal of the second portion of the cartridge when the first and second portions of the cartridge are moved from the storage configuration to the use configuration.

When the first and second portions of the cartridge are moved from the storage configuration to the use configuration, the one or more piercing elements of the susceptor holder may pierce the seal and enable the aerosol-forming substrate to flow from the first portion of the reservoir to the second portion of the reservoir.

The susceptor assembly may extend into the second portion of the reservoir. Where the susceptor assembly comprises a wicking element, a portion of the wicking element may extend into the second portion of the reservoir. Accordingly, when the cartridge is in the storage configuration, the susceptor assembly is isolated from the aerosol-forming substrate, and when the cartridge is in the use configuration, the susceptor assembly is supplied with aerosol-forming substrate from the second portion of the reservoir.

The seal may be any suitable type of seal for preventing fluid flow between the first portion of the reservoir and the second portion of the reservoir. For example, the seal may comprise a metal foil, a plastic foil, or an elastomeric seal.

The first and second portions of the cartridge may be movable relative to each other in any suitable manner. In some embodiments, the first and second portions of the cartridge may be slidable relative to each other. In some embodiments, the first and second portions of the cartridge may be rotatable relative to each other.

The aerosol-generating system may be a handheld aerosol-generating system configured to allow a user to puff on a mouthpiece to draw an aerosol through a mouth end opening. The aerosol-generating system may have a size comparable to a conventional cigar or cigarette. The aerosol-generating system may have a total length between about 30 mm and about 150 mm. The aerosol-generating system may have an external diameter between about 5 mm and about 30 mm.

The aerosol-generating system may be configured to deliver nicotine or cannabinoids to a user. The aerosol-generating system may be an electrically operated smoking device.

According to the present disclosure there is also provided a susceptor assembly for an electrically heated aerosol-generating system comprising a housing defining a reservoir containing an aerosol-forming substrate, at least one inductor coil and a power supply connected to the at least one inductor coil and configured to provide an oscillating current to the at least one inductor coil so that the inductor coil generates an alternating magnetic field. The susceptor assembly may comprise a first susceptor element configured to be heated by the alternating magnetic field. The susceptor assembly may comprise a second susceptor element configured to be heated by the alternating magnetic field. The susceptor assembly may comprise a wicking element configured to be in fluid communication with the reservoir of the aerosol-generating system. The first and second susceptor elements are integral with or fixed to the wicking element. A space may be defined between the first and second susceptor elements, the wicking element occupying the space.

Below, there is provided a non-exhaustive list of non-limiting examples. Any one or more of the features of these examples may be combined with any one or more features of another example, embodiment, or aspect described herein.

EX1. An electrically heated aerosol-generating system comprising:
at least one inductor coil;
a power supply connected to the at least one inductor coil and configured to provide an alternating current to the at least one inductor coil to generate an alternating magnetic field; a housing containing a reservoir of aerosol-forming substrate; and
a substantially planar susceptor assembly, the susceptor assembly configured to be heated by the alternating magnetic field and comprising a first susceptor element, a second susceptor element and a wicking element in fluid communication with the reservoir, the first and second susceptor elements being integral with or fixed to the wicking element;
wherein a space is defined between the first and second susceptor elements, the wicking element occupying the space and the reservoir being positioned outside the space.

EX2. An electrically heated aerosol-generating system according to example EX1, wherein the first and second susceptor element are fluid permeable.

EX3. An electrically heated aerosol-generating system according to example EX1 or EX2, wherein the aerosol-forming substrate is a liquid.

EX4. An aerosol-generating system according to any one of examples EX1 to EX3, wherein the wicking element is arranged to convey aerosol-forming substrate from the liquid reservoir across a major surface of the susceptor element.

EX5. An electrically heated aerosol-generating system according to example EX3 or EX4, wherein the susceptor assembly, or a heating region of the susceptor assembly, holds between 2 and 10 millilitres of liquid aerosol-forming substrate.

EX6. An aerosol-generating system according to any one of the preceding examples, wherein at least a portion of each of two opposing major surfaces of the susceptor assembly is in direct contact with air in an airflow passage in the system.

EX7. An electrically heated aerosol-generating system according to any one of the preceding examples, wherein the first and second susceptor elements have a relative permeability between 1 and 40000, preferably between 500 and 40000.

EX8. An electrically heated aerosol-generating system according to any one of the preceding examples, wherein the alternating current has a frequency of between 100 kHz and 30 MHz, preferably between 500 kHz and 30 MHz.

EX9. An electrically heated aerosol-generating system according to any one of examples EX1 to EX7, wherein the alternating current has a frequency of between 100 kHz and 1000 MHz.

EX10. An electrically heated aerosol-generating system according to any one of the preceding examples, wherein the thickness of each susceptor element is of the same order or less than the skin depth of the material of the susceptor element at the frequency of operation of the system.

EX11. An aerosol-generating system according to any one of the preceding examples, wherein each susceptor element has a thickness of no greater than two millimetres.

EX12. An electrically heated aerosol-generating system according to any one of the preceding examples, wherein the first and second susceptor elements comprise electrically conductive filaments.

EX13. An electrically heated aerosol-generating system according to example EX12, wherein the first and second susceptor elements comprise a mesh, flat spiral coil, fibres or fabric of the electrically conductive filaments.

EX14. An electrically heated aerosol-generating system according to example EX12 or EX13, wherein the electrically conductive filaments have a diameter of between 40 micrometres and 60 micrometres, preferably between 45 and 55 micrometres and even more preferably 50 micrometres.

EX15. An electrically heated aerosol-generating system according to any one of examples EX12 to EX14, wherein the mesh aperture of a mesh of the electrically conductive filaments is between 60 and 150 micrometres, preferably between 50 to 70 micrometres, even more preferably between 60 and 65 micrometres and most preferably 63 micrometres.

EX16. An electrically heated aerosol-generating system according to any one of the preceding examples, wherein the first and second susceptor elements comprise an electrically conductive material printed or otherwise deposited on to the wicking element.

EX17. An electrically heated aerosol-generating system according to example EX16, wherein the electrically conductive material of the first or second susceptor element is printed or otherwise deposited on to the wicking element as a film or a plurality of tracks.

EX18. An electrically heated aerosol-generating system according to example EX17, wherein the plurality of tracks of each of the susceptor elements are distributed over a surface of the wicking element.

EX19. An electrically heated aerosol-generating system according to example EX17 or EX18, wherein the plurality of tracks of each of the susceptor elements form a mesh-like structure.

EX20. An electrically heated aerosol-generating system according to any one of examples EX1 to EX11, wherein the first and second susceptor elements comprise a perforated foil.

EX21. An electrically heated aerosol-generating system according to example EX20, wherein the perforations are uniformly distributed across the first and second susceptor elements.

EX22. An electrically heated aerosol-generating system according to any one of the preceding examples, wherein the wicking element comprises an electrically insulating material.

EX23. An electrically heated aerosol-generating system according to any one of the preceding examples, wherein the wicking element comprises a non-metallic material.

EX24. An electrically heated aerosol-generating system according to any one of the preceding examples, wherein the wicking element comprises a hydrophilic material or an oleophilic material.

EX25. An electrically heated aerosol-generating system according to any one of the preceding examples, wherein the wicking element comprises cotton, rayon or glass fibre.

EX26. An electrically heated aerosol-generating system according to any one of examples EX1 to EX24, wherein the wicking element comprises a porous ceramic material.

EX27. An electrically heated aerosol-generating system according to any one of the preceding examples, wherein the at least one inductor coil comprises a first inductor coil and a second inductor coil.

EX28. An electrically heated aerosol-generating system according to example EX27, wherein the first inductor coil is positioned on a first side of the susceptor assembly and the second inductor coil is positioned on a second side of the susceptor assembly and extends parallel to the first plane.

EX30. An electrically heated aerosol-generating system according to claim 28 or 29, wherein the susceptor assembly is substantially equidistant from the first and second inductor coils.

EX31. An aerosol-generating system according to any one of examples EX27 to EX30, wherein the system is configured so that the first and second inductor coils produce equal and opposite magnetic fields to one another.

EX32. An aerosol-generating system according to any one of examples EX28 to EX31, wherein the system is configured so that the first and second inductor coils provide a magnetic field at the susceptor assembly that is normal to the first plane.

EX33. An aerosol-generating system according to any one of examples EX27 to EX32, wherein each of the planar inductor coils is rectangular.

EX34. An aerosol-generating system according to any one of examples EX27 to EX33, wherein the first inductor coil has the same number of turns as the second inductor coil.

EX35. An aerosol-generating system according to any one of examples EX27 to EX34 wherein the first inductor coil has the same size and shape as the second inductor coil.

EX36. An aerosol-generating system according to any one of examples EX27 to EX35, wherein the first inductor coil is substantially identical to the second inductor coil.

EX37. An aerosol-generating system according to any one of examples EX27 to EX36, wherein the first inductor coil has an identical electrical resistance to the second inductor coil.

EX38. An aerosol-generating system according to any one of examples EX27 to EX37, wherein the inductor coils are electrically connected to form a single conductive path, and wherein the first inductor coil is wound in an opposite sense to the second inductor coil.

EX39. An aerosol-generating system according to any one of examples EX27 to EX38, wherein the first and second inductor coils are provided with an identical alternating electrical current.

EX40. An aerosol-generating system according to any one of examples EX27 to EX39, wherein the first inductor coil is wound in the same sense to the second inductor coil, and wherein the control circuitry is configured to provide current to the first inductor coil that is directly out of phase with the current provided to the second inductor coil.

EX41. An aerosol-generating system according to any one of examples EX27 to EX40, comprising one or more flux concentrators configured to contain a magnetic field generated by the inductor coils.

EX42. An aerosol-generating system according to any one of the preceding examples, further comprising a susceptor assembly holder and wherein each of the susceptor elements comprises a heating region and at least one mounting region, wherein the heating region is a region of the susceptor element that is configured to be heated to a temperature required to vapourise a liquid aerosol-forming substrate from the liquid reservoir upon penetration by a suitable alternating magnetic field, and wherein the at least one mounting region of the susceptor element is a region of the susceptor element that is configured to contact the susceptor holder.

EX43. An aerosol-generating system according to example EX42, wherein the heating region is configured to heat to a substantially higher temperature than the mounting region in the presence of an alternating magnetic field.

EX44. An aerosol-generating system according to example EX42 or EX43, wherein the heating region is located in a space directly between the first and second inductor coils and the mounting region may be located outside the space directly between the first and second inductor coils.

EX45. An aerosol-generating system according to any one of examples EX42 to EX44, wherein the heating region of each of the susceptor elements is arranged outside of the liquid reservoir.

EX46. An electrically heated aerosol-generating system according to any one of the preceding examples, further comprising an airflow passage extending between an air inlet and an air outlet.

EX47. An electrically heated aerosol-generating system according to example EX46, wherein the air outlet is defined in a mouthpiece of the system.

EX48. An electrically heated aerosol-generating system according to example EX46 or EX47, wherein the airflow in the airflow passage passes over a surface of the first susceptor element and a surface of the second susceptor element.

EX49. An electrically heated aerosol-generating system according to any one of examples EX46 to EX48, wherein the wicking element is in fluid communication with the reservoir because the wicking element protrudes into the reservoir.

EX50. An electrically heated aerosol-generating system according to any one of the preceding examples, wherein the housing comprises an inner wall and an outer wall such that an internal passage is defined by the inner wall.

EX51. An electrically heated aerosol-generating system according to example EX50, wherein the internal passage is surrounded by a space defined between the inner wall and outer wall.

EX52. An electrically heated aerosol-generating system according to example EX51, wherein the space surrounding the internal passage is an annular space.

EX53. An electrically heated aerosol-generating system according to example EX51 or EX52, wherein the airflow channel may be at least partially defined by the internal passage and the reservoir is at least partially defined by the space surrounding the internal passage.

EX54. An electrically heated aerosol-generating system according to example EX51 or EX52, wherein the reservoir is at least partially defined by the internal passage and the airflow passage is at least partially defined by the annular space.

EX55. An electrically heated aerosol-generating system according to any one of the preceding examples, wherein the aerosol-generating system comprises a susceptor assembly holder onto which the susceptor assembly is mounted.

EX56. An electrically heated aerosol-generating system according to example EX55, wherein the susceptor elements of the susceptor assembly each comprise at least one mounting region that contacts the holder.

EX57. An electrically heated aerosol-generating system according to example EX55 or EX56, wherein the susceptor assembly holder is tubular and has at least one sidewall.

EX58. An electrically heated aerosol-generating system according to example EX57, wherein the susceptor assembly is mounted by at least one opening through the sidewall.

EX59. An electrically heated aerosol-generating system according to example EX57 or EX58, wherein the susceptor assembly is mounted by at least two openings through the sidewall.

EX60. An electrically heated aerosol-generating system according to any one of examples EX55 to EX59, wherein the susceptor assembly holder is configured to withstand the temperatures to which the susceptor assembly is raised for heating of the aerosol-forming substrate.

EX61. An electrically heated aerosol-generating system according to any one of examples EX55 to EX60, wherein the susceptor assembly holder is formed from a liquid impermeable material.

EX62. An electrically heated aerosol-generating system according to any one of examples EX55 to EX61, wherein the susceptor holder is formed form a mouldable plastics material, such as polypropylene (PP) or polyethylene terephthalate (PET).

EX63. An electrically heated aerosol-generating system according to any one examples EX57 to EX62, wherein the at least one sidewall of the susceptor assembly holder forms at least part of an inner wall of the housing.

EX64. An electrically heated aerosol-generating system according to example EX63, wherein the housing comprises an inner wall and an outer wall such that an internal passage is defined by the inner wall and wherein the at least one sidewall of the housing defines part of the internal passage.

EX65. An electrically heated aerosol-generating system according to example EX64, wherein the space between the inner wall and outer wall is at least partially defined between the at least one sidewall and the outer wall of the housing.

EX66. An electrically heated aerosol-generating system according to example EX65, wherein the susceptor assembly extends into the internal passage of the susceptor holder.

EX67. An electrically heated aerosol-generating system according to any one of examples EX55 to EX66, wherein the holder is moulded onto the susceptor assembly.

EX68. An electrically heated aerosol-generating system according to example EX67, wherein the moulded holder retains the first and second susceptor elements and the wicking element together such that the elements are fixed together

EX69. An electrically heated aerosol-generating system according to any one of the preceding examples, wherein the susceptor assembly is surrounded by a permeable electrically insulating coating.

EX70. An electrically heated aerosol-generating system according to example EX69, wherein the coating comprises a permeable ceramic material.

EX71. An electrically heated aerosol-generating system according to any one of the preceding examples, wherein the susceptor assembly further comprises a third susceptor element and a second wicking element, the second wicking element being positioned between the first susceptor element and the third susceptor element or the second susceptor element and the third susceptor element.

EX72. An electrically heated aerosol-generating system according to any one of the preceding examples, further comprises a second susceptor assembly substantially similar to the first susceptor assembly.

EX73. An electrically heated aerosol-generating system according to any one of the preceding examples, wherein the system further comprises electric circuitry connected to the at least one inductor coil and to an electrical power source.

EX74. An electrically heated aerosol-generating system according to any one of the preceding examples, wherein the aerosol-generating system comprises an aerosol-generating device and a cartridge configured to be used with the device that comprises the at least one inductor coil, the power supply and a device housing configured to engage at least a portion of the cartridge when the cartridge is used with the aerosol-generating device.

EX75. An electrically heated aerosol-generating system according to example EX74, wherein the cartridge comprises the susceptor assembly and a cartridge housing.

EX76. An electrically heated aerosol-generating system according to example EX74 or EX75, wherein the at least one inductor coil is positioned around or adjacent the susceptor assembly when the cartridge is engaged with the aerosol-generating device.

EX77. An electrically heated aerosol-generating system according to any one of examples EX74 to EX76, wherein the aerosol-generating system comprises a first and second inductor coil, the first inductor coil being positioned on a first side of the cartridge and the second inductor coil being positioned on a second side of the cartridge when cartridge is engaged with the aerosol-generating device.

EX78. An electrically heated aerosol-generating system according to example EX77, wherein the portion of the cartridge comprising the susceptor assembly of the cartridge is located between the first and second inductor coil when the cartridge is engaged with the aerosol-generating device.

EX79. A cartridge for use in an electrically heated aerosol-generating system, the electrically heated aerosol-generating system comprising an aerosol-generating device, the cartridge being configured to be used with the device, wherein the device comprises: a device housing configured to engage at least a portion of the cartridge when the cartridge is used with the aerosol-generating device; at least one inductor coil; and a power supply connected to the at least one inductor coil and configured to provide an alternating current to the at least one inductor coil so that the inductor coil generates an alternating magnetic field within the cartridge; the cartridge comprising:
a cartridge housing defining a reservoir containing an aerosol-forming substrate; and
a substantially planar susceptor assembly configured to be heated by the alternating magnetic field and comprising a first susceptor element, a second susceptor element and a wicking element in fluid communication with the reservoir, the first and second susceptor elements being integral with or fixed to the wicking element;
wherein a space is defined between the first and second susceptor elements, the wicking element occupying the space and the reservoir being positioned outside the space.
occupying the space and the reservoir being positioned outside the space.

EX80. A cartridge according to example EX79, wherein the first and second susceptor element are fluid permeable.

EX81. A cartridge according to example EX79 or EX80, wherein the aerosol-forming substrate is a liquid.

EX82. A cartridge according to any one of examples EX79 to EX81, wherein the wicking element is arranged to convey aerosol-forming substrate from the liquid reservoir across a major surface of the susceptor element.

EX83. A cartridge according to example EX81 or EX82 wherein the susceptor assembly, or a heating region of the susceptor assembly, holds between 2 and 10 millilitres of liquid aerosol-forming substrate.

EX84. A cartridge according to any one of examples EX79 to EX83, wherein at least a portion of each of two opposing major surfaces of the susceptor assembly is in direct contact with air in an airflow passage in the system.

EX85. A cartridge according to any one of examples EX79 to EX84, wherein the first and second susceptor elements have a relative permeability between 1 and 40000, preferably between 500 and 40000.

EX86. A cartridge according to any one of examples EX79 to EX85, wherein the thickness of each susceptor element is of the same order or less than the skin depth of the material of the susceptor element at the frequency of operation of the system.

EX87. A cartridge according to any one of examples EX79 to EX86, wherein the susceptor assembly has a thickness of no greater than two millimetres.

EX88. A cartridge according to any one of examples EX79 to EX87, wherein the first and second susceptor elements comprise electrically conductive filaments.

EX89. A cartridge according to example EX88, wherein the first and second susceptor elements comprise a mesh, flat spiral coil, fibres or fabric of the electrically conductive filaments.

EX90. A cartridge according to example EX88 or EX89, wherein the electrically conductive filaments have a diameter of between 40 micrometres and 60 micrometres, preferably between 45 and 55 micrometres and even more preferably 50 micrometres.

EX91. A cartridge according to any one of examples EX88 to EX90, wherein the mesh aperture of a mesh of the electrically conductive filaments is between 60 and 150 micrometres, preferably between 50 to 70 micrometres, even more preferably between 60 and 65 micrometres and most preferably 63 micrometres.

EX92. A cartridge according to any one of examples EX79 to EX91, wherein the first and second susceptor elements comprise an electrically conductive material printed or otherwise deposited on to the wicking element.

EX93. A cartridge according to example EX92, wherein the electrically conductive material of the first or second susceptor element is printed or otherwise deposited on to the wicking element as a film or a plurality of tracks.

EX94. A cartridge according to example EX93, wherein the plurality of tracks of each of the susceptor elements are distributed over a surface of the wicking element.

EX95. A cartridge according to example EX93 or EX94, wherein the plurality of tracks of each of the susceptor elements form a mesh-like structure.

EX96. A cartridge according to any one of examples EX79 to EX91, wherein the first and second susceptor elements comprise a perforated foil.

EX97. A cartridge according to example EX96, wherein the perforations are uniformly distributed across the first and second susceptor elements.

EX98. A cartridge according to any one of examples EX79 to EX97, wherein the wicking element comprises an electrically insulating material.

EX99. A cartridge according to any one of examples EX79 to EX98, wherein the wicking element comprises a non-metallic material.

EX100. A cartridge according to any one of examples EX79 to EX99, wherein the wicking element comprises a hydrophilic material or an oleophilic material.

EX101. A cartridge according to any one of examples EX79 to EX100, wherein the wicking element comprises cotton or rayon.

EX102. A cartridge according to any one of examples EX79 to EX101, wherein the wicking element comprises a porous ceramic material.

Features described in relation to one example or embodiment may also be applicable to other examples and embodiments.

Examples will now be further described with reference to the figures in which:

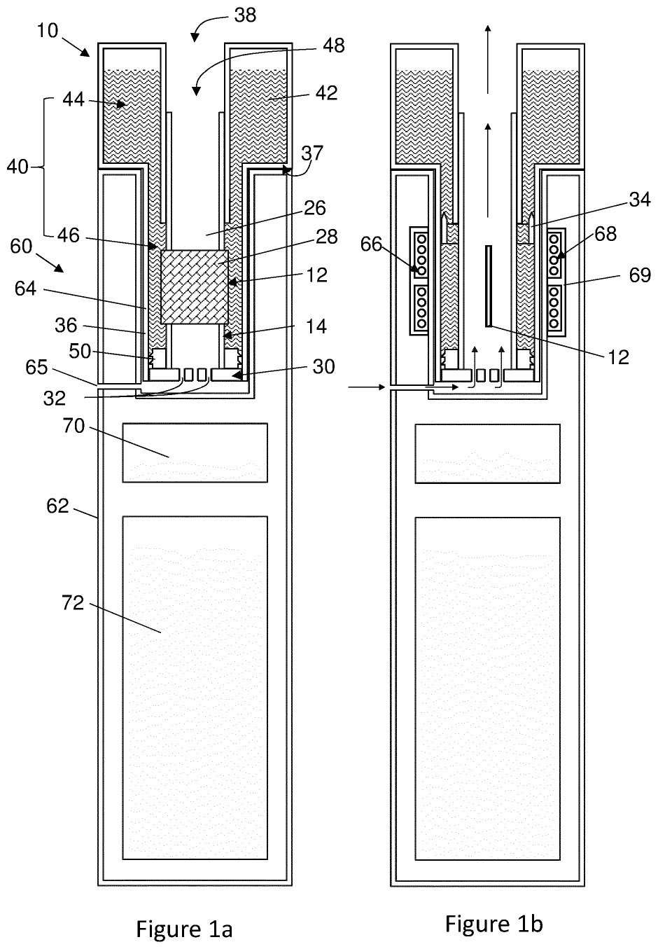

FIG. 1a is a schematic illustration of an aerosol-generating system according to an example of the present disclosure;

FIG. 1b is a schematic illustration of the aerosol-generating system of FIG. 1a rotated by 90 degrees about a central longitudinal axis of the aerosol-generating system;

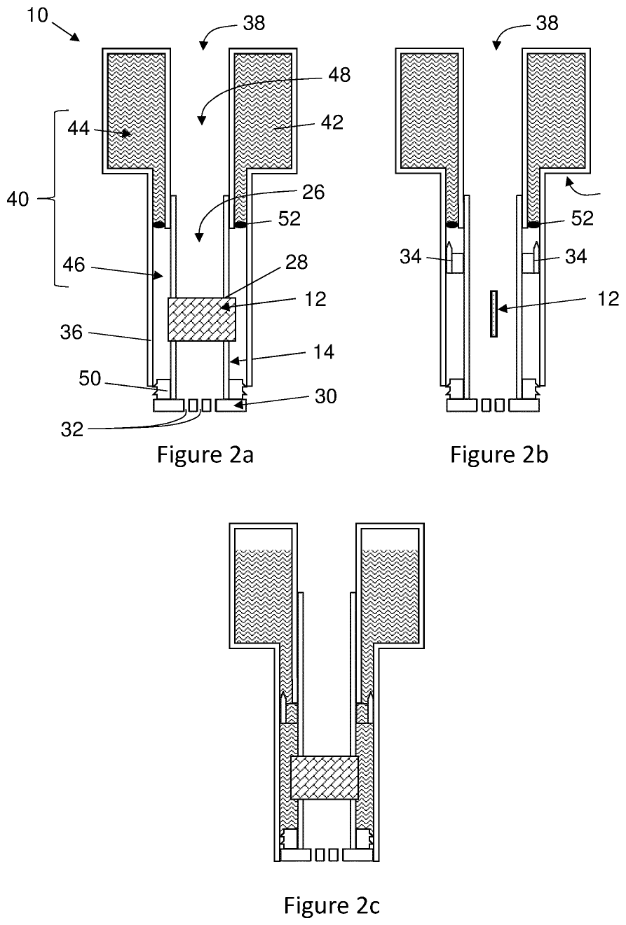

FIGS. 2a-c are schematic illustrations of the cartridge from the system of FIGS. 1a and 1b;

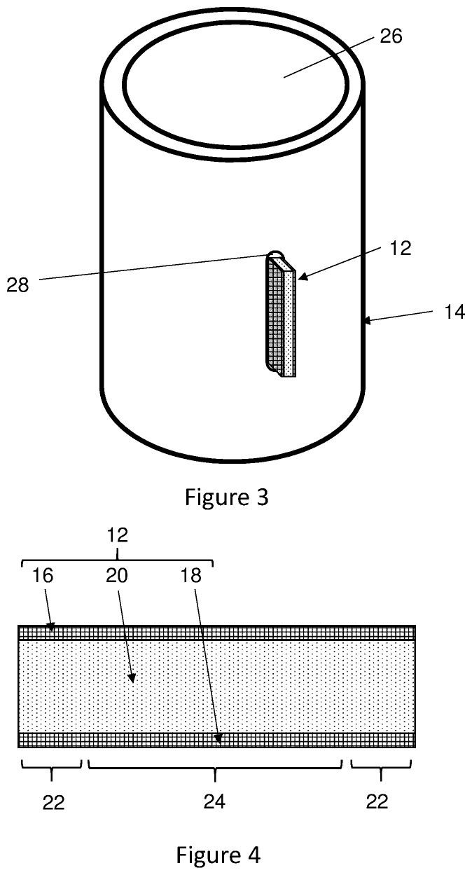

FIG. 3 is a perspective view of the susceptor assembly and susceptor assembly holder according to the disclosure, separately from the rest of the aerosol-generating system;

FIG. 4 is a plan view of the susceptor assembly of FIGS. 1 and 2 separately from the rest of the aerosol-generating system;

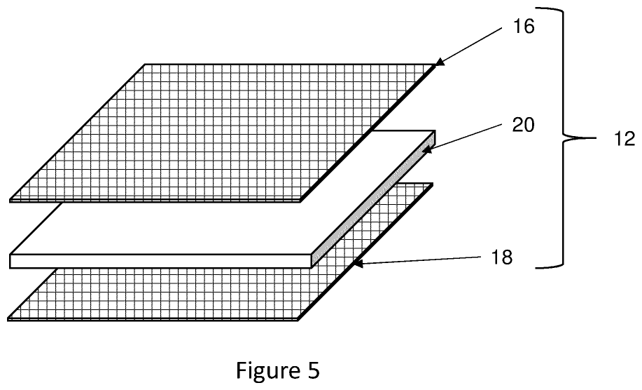

FIG. 5 is an exploded perspective view of an embodiment of a susceptor assembly according to the disclosure;

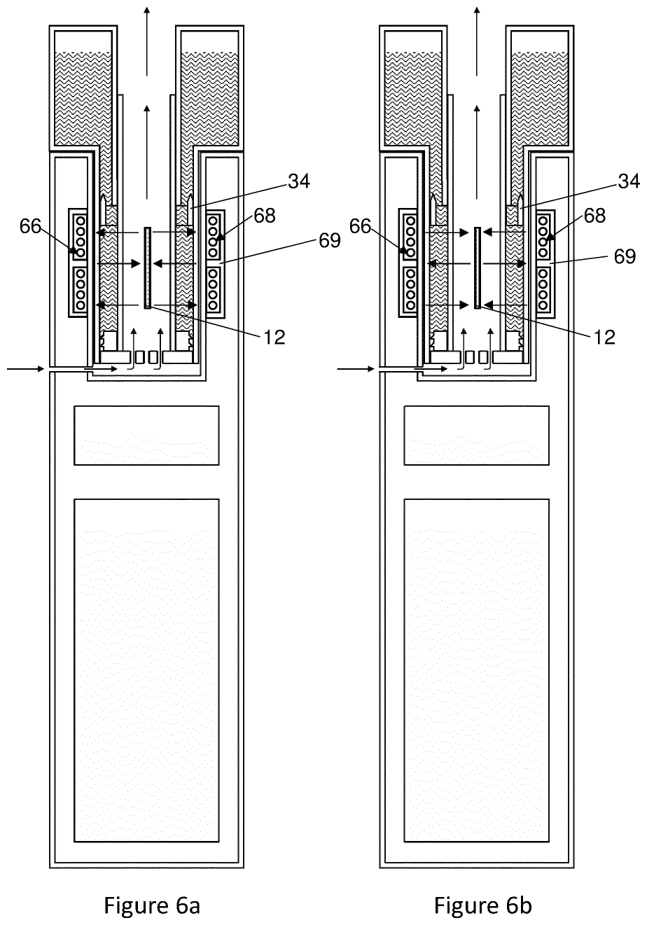

FIG. 6a is an illustration of the system of FIG. 1b with the magnetic field lines shown for one phase of operation;

FIG. 6b is an illustration of the system of FIG. 1b with the magnetic field lines shown for a subsequent phase of operation;

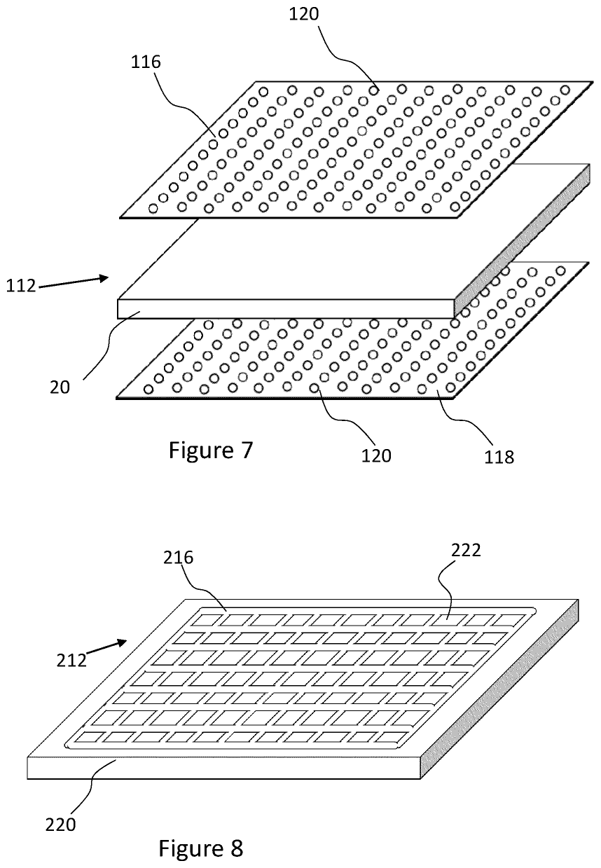

FIG. 7 is an exploded perspective view of another embodiment of a susceptor assembly according to the disclosure;

FIG. 8 is a perspective view of a further embodiment of a susceptor assembly according to the disclosure;

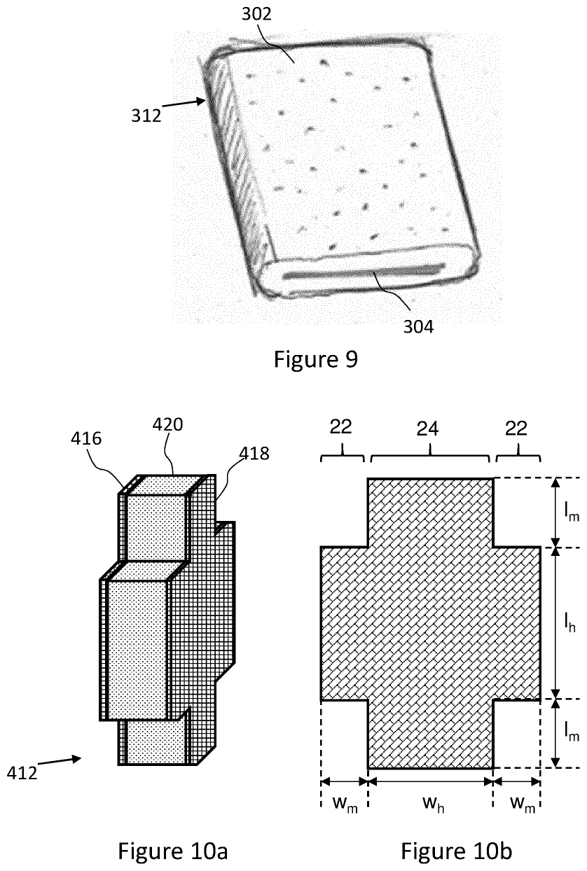

FIG. 9 is perspective view of a susceptor assembly comprising a coating according to the disclosure;

FIG. 10a is a perspective view of an embodiment of a susceptor assembly according to the disclosure having a different shape to the susceptor assembly of FIG. 4;

FIG. 10b is a plan view of the susceptor assembly of FIG. 10a;

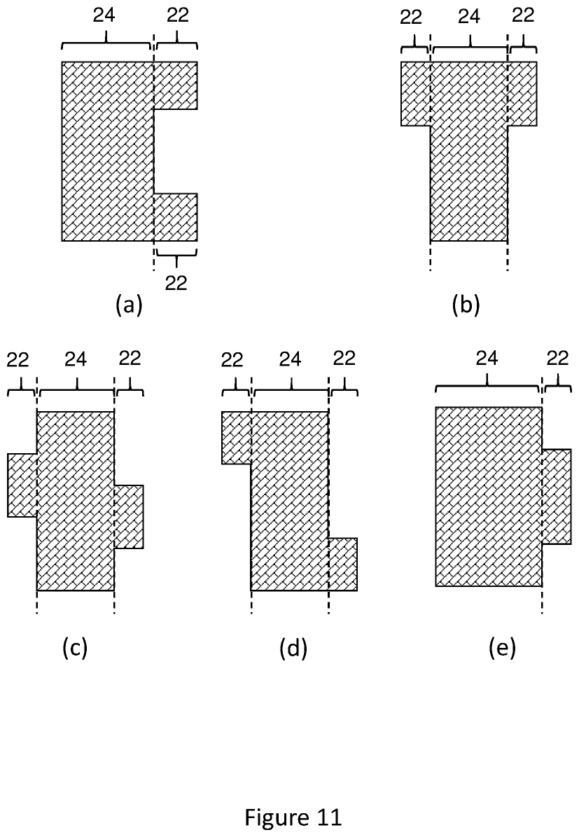

FIGS. 11a-d are plan views of exemplary susceptor elements according to the present disclosure;

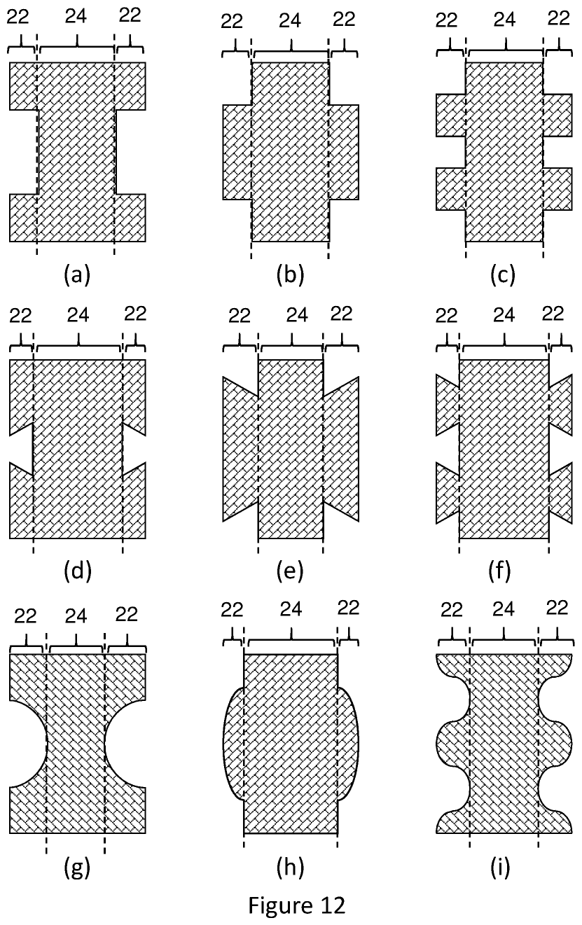

FIGS. 12a-i are plan views of further exemplary susceptor elements according to the present disclosure;

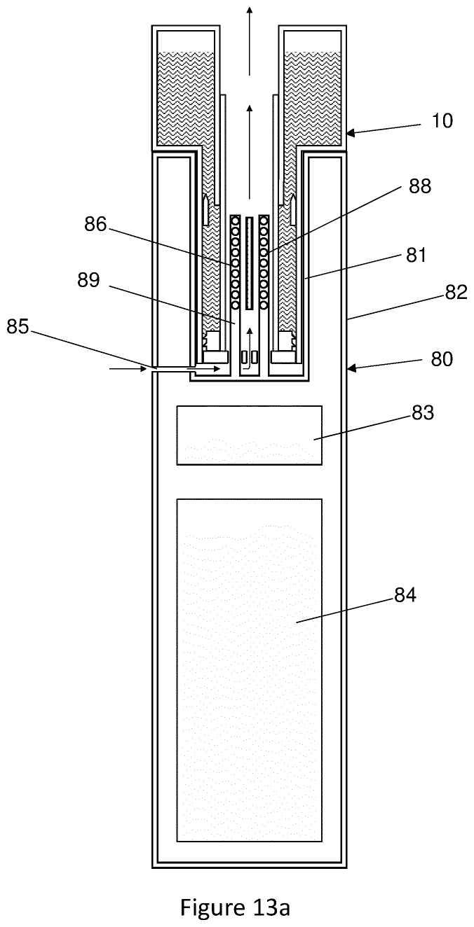

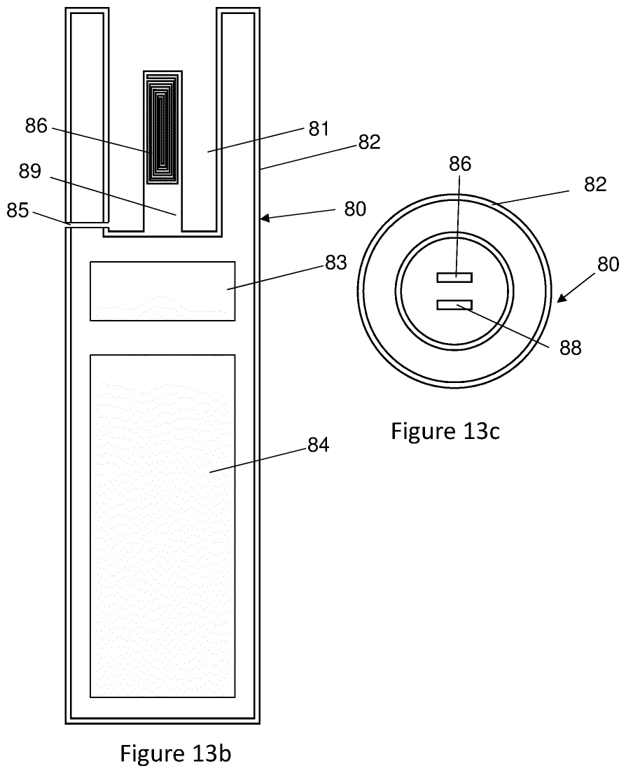

FIG. 13a is a schematic illustration of an aerosol-generating system according to another example of the present disclosure;

FIG. 13b is a schematic illustration of the device part of FIG. 13a, rotated 90 degrees about a central longitudinal axis of the aerosol-generating system;

FIG. 13c is an end view of the device of FIG. 13b;

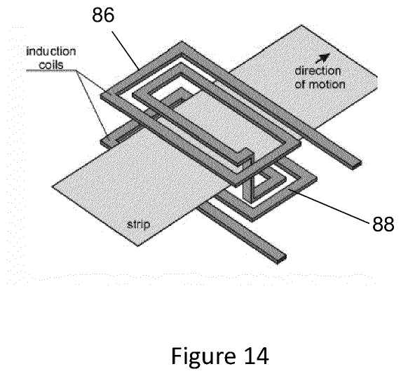

FIG. 14 is a schematic illustration of the arrangement of coils and susceptor in one embodiment;

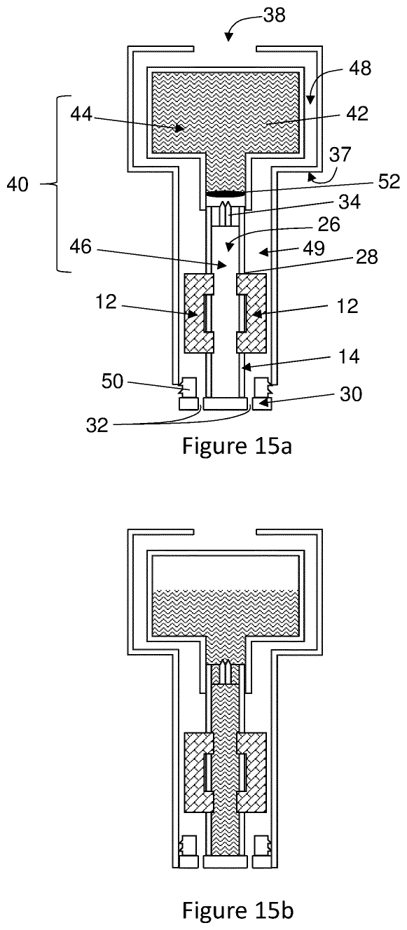

FIG. 15a is a schematic illustration of a cartridge for an aerosol-generating system prior to use according to a further example of the present disclosure;

FIG. 15b is a schematic illustration of the cartridge of FIG. 9a in a use configuration;

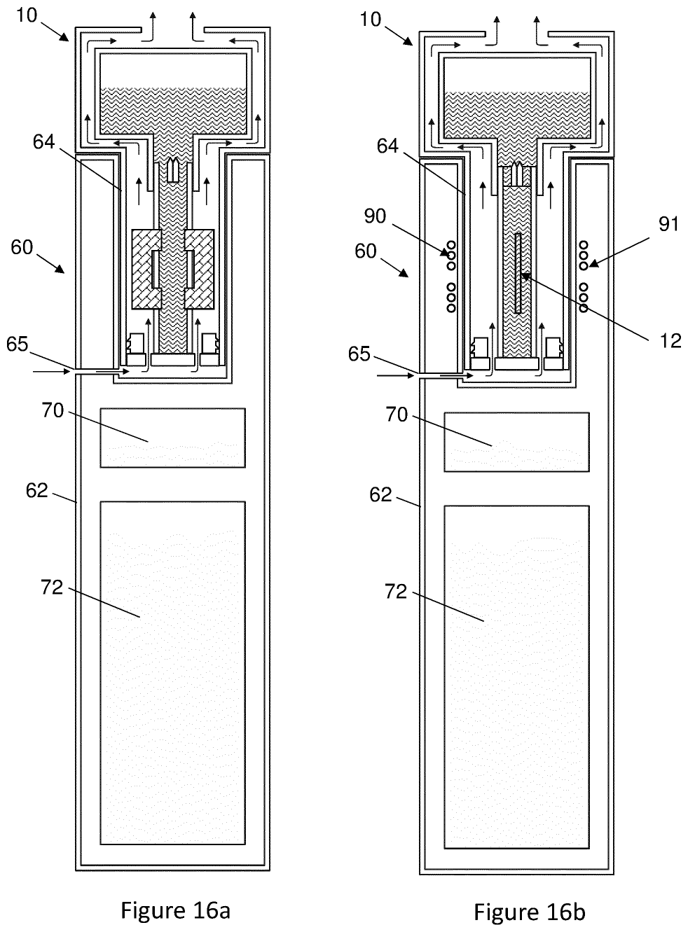

FIG. 16a is a system including the cartridge of FIG. 15b;

FIG. 16b is the system of FIG. 16a rotated by 90 degrees about a central longitudinal axis of the aerosol-generating system;

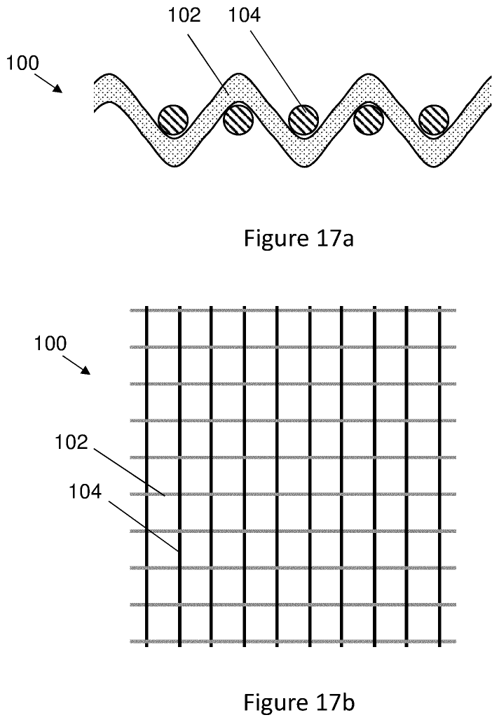

FIG. 17a is a cross-sectional view of a planar susceptor element according to another example of the present disclosure, the cross-section being taken in a plane normal to the plane of the susceptor element; and

FIG. 17b is a plan view of the susceptor element of FIG. 17a.

FIG. 1a shows a schematic illustration of an aerosol-generating system according to an example of the present disclosure. FIG. 1b shows a schematic illustration of the aerosol-generating system of FIG. 1a rotated by 90 degrees about a central longitudinal axis of the aerosol-generating system. The system comprises a cartridge 10 and a device 60, which are coupled together to form the aerosol-generating system. The aerosol-generating system is portable and has a size comparable to a conventional cigar or cigarette.

The cartridge 10 comprises a susceptor assembly 12 mounted in a susceptor holder 14. FIGS. 2a-c show the cartridge 10 separately from the aerosol-generating system. FIG. 3 shows a perspective view of the susceptor assembly 12 and holder 14 separately from the rest of the aerosol-generating system. FIGS. 4 and 5 show the structure of the susceptor assembly 12 more clearly. FIG. 4 is cross-sectional schematic view of the susceptor assembly 12. FIG. 5 is an exploded schematic view of the susceptor assembly 12.

The susceptor assembly 12 is planar, and thin, having a thickness dimension that is substantially smaller than a length dimension and a width dimension. The susceptor assembly 12 comprises three elements, a first susceptor element 16, a second susceptor element 18, and a wicking element 20 arranged between the first and second susceptor elements 16, 18. Each of the first susceptor element 16, the second susceptor element 18, and the wicking element 20 has the same length and width dimensions. The first and second susceptor elements 16, 18 are substantially identical, and comprise a sintered mesh formed from ferritic stainless steel filaments and austenitic stainless steel filaments, as described in more detail below. The wicking element 20 comprises a porous body of rayon filaments. The wicking element 20 is configured to deliver liquid from the outer, exposed surfaces of the wicking element 20 to the first and second susceptor elements 16, 18.

Each of the first and second susceptor elements 16, 18 comprises a mesh having filaments extending in a first direction, and filaments extending in a second direction, substantially perpendicular to the first direction. The electrically conductive filaments comprise filaments formed from AISI 430 stainless steel. The aperture of the mesh is 63 micrometres and the diameter of the of electrically conductive filaments is 50 micrometres.

Each of the first and second susceptor elements 16, 18 comprises a pair of mounting regions 22 and a heating region 24. The heating region 24 is a substantially rectangular region located centrally on the susceptor elements 16, 18. The pair of mounting regions 22 are also substantially rectangular regions located at the periphery of the heating region 24, at opposite sides of the heating region 24. The heating region 24 is configured to be heatable by penetration with an alternating magnetic field, for vapourising an aerosol-forming substrate. The pair of mounting regions 22 are configured to contact the susceptor holder 14, such that the susceptor holder 14 can support the susceptor assembly 12 in position in the cartridge 10.

The pair of mounting regions 22 comprise filaments of AISI 316 stainless steel in addition to filaments of AISI 430 stainless steel extending in the first direction, and, an austenitic stainless steel, extending in the second direction. Accordingly, the heating region 24 is comprised of a magnetic material, and the pair of mounting regions 22 are in part comprised of a magnetic material, and in part comprised of a non-magnetic material. The proportion by weight of the AISI 430 stainless steel in the heating region 24 is greater than the proportion by weight of the AISI 430 in each of the pair of mounting regions 22.

Accordingly, the heating region 24 is comprised of a magnetic material, and the pair of mounting regions 22 are in part comprised of a magnetic material, and in part comprised of a non-magnetic material. The proportion by weight of the AISI 430 stainless steel in the heating region 24 is greater than the proportion by weight of the AISI 430 stainless steel in each of the pair of mounting regions 22. This helps to reduce heating of the mounting regions 22 when the susceptor elements are penetrated by an alternating magnetic field. Such a configuration also helps to reduce heat transfer from the susceptor assembly 12 to the susceptor holder 14.

It will be appreciated that in other embodiments the heating region 24 and the pair of mounting regions 22 may be formed from other combinations of magnetic and non-magnetic materials. For example, in some embodiments the heating region 24 comprises filaments of AISI 430 stainless steel, a ferritic stainless steel, extending in the first direction, and filaments of AISI 316 stainless steel, an austenitic stainless steel, extending in the second directions. In these embodiments, the pair of mounting regions 22 may comprise filaments of AISI 316 stainless steel extending in both the first and second directions. Accordingly, in these embodiments, the heating region 24 is in part comprised of a magnetic material, and in part comprised of a non-magnetic material, and the pair of mounting regions 22 consist of a non-magnetic material.

The susceptor holder 14 comprises a tubular body formed from a mouldable plastic material, such as polypropylene. The tubular body of the susceptor holder 14 comprises a side wall defining an internal passage 26, having open ends. A pair of openings 28 extend through the side wall, at opposite sides of the tubular susceptor holder 14. The openings 28 are arranged centrally along the length of the susceptor holder 14.

The susceptor assembly 12 is arranged inside the internal passage 26 of the tubular susceptor holder 14, and extends in a plane parallel to a central longitudinal axis of the susceptor holder 14. The heating region 24 of the first and second susceptor elements 16, 18 is arranged entirely within the internal passage 26 of the susceptor holder 14, and each of the mounting regions 22 extends through one of the openings 28 in the side wall of the susceptor holder 14. The openings 28 in the side wall of the susceptor holder 14 are sized to accommodate the susceptor assembly 12 with a friction fit, such that the susceptor assembly is secured in the susceptor holder 14. The friction fit between the susceptor assembly 12 and the susceptor holder 14 results in the mounting regions 22 directly contacting the susceptor holder 14 at the openings 28. The susceptor assembly 12 and the susceptor holder 14 are secured together such that movement of the susceptor holder 14 also moves the susceptor assembly 12.

It will be appreciated that the susceptor assembly 12 and the susceptor holder 14 may be secured together by other means. For example, in some embodiments the susceptor assembly 12 is secured to the susceptor holder 14 by an adhesive at the mounting regions 22 of the susceptor assembly 12, such that the mounting regions 22 indirectly contact the susceptor holder 14.

The susceptor holder 14 comprises a base 30 that partially closes one end of the internal passage 26. The base 30 comprises a plurality of air inlets 32 that enable air to be drawn into the internal passage 26 through the partially closed end.

The susceptor holder 14 further comprises a pair of piercing elements 34 extending from an outer surface of the side wall, towards the open end of the susceptor holder 14 opposite the end partially closed by the base 30. The openings 28 in the sidewall of the susceptor holder 14 are arranged between the piercing elements 34 around the circumference of the side wall, such that the piercing elements 34 are offset from the openings 28 around the circumference of the side wall of the tubular susceptor by about 90 degrees. Each of the piercing elements 34 comprises a spike facing in the direction of the open end of the susceptor holder 14.

The cartridge 10 further comprises an outer housing 36 formed from a mouldable plastics material, such as polypropylene. The outer housing 36 generally forms a hollow cylinder, defining an internal space in which the susceptor assembly 12 and the susceptor holder 14 are contained.

The outer housing 36 forms a first portion of the cartridge 10, and the susceptor assembly 12 and the susceptor holder 14 form a second portion of the cartridge 10. The second portion of the cartridge is slidable relative to the first portion of the cartridge between a storage configuration, as shown in FIGS. 2a and 2b, and a use configuration, as shown in FIG. 2c.

The cartridge 10 has a mouth end, and a connection end, opposite the mouth end. The outer housing 36 defines a mouth end opening 38 at the mouth end of the cartridge 10. The connection end is configured for connection of the cartridge 10 to an aerosol-generating device, as described in detail below. The susceptor assembly 12 and the susceptor holder 14 are located towards the connection end of the cartridge 10. The external width of the outer housing 36 is greater at the mouth end of the cartridge 10 than at the connection end, which are joined by a shoulder 37. This enables the connection end of the cartridge to be received in a cavity of an aerosol-generating device, with the shoulder 37 locating the cartridge in the correct position in the device. This also enables the mouth end of the cartridge 10 to remain outside of the aerosol-generating device, with the mouth end conforming to the external shape of the aerosol-generating device.

A liquid reservoir 40 is defined in the cartridge for holding a liquid aerosol-forming substrate 42. The liquid reservoir 40 is divided into two portions, a first portion 44 and a second portion 46. The first portion 44 of the liquid reservoir 40 is located towards the mouth end of the outer housing 36, and comprises an annular space defined by the outer housing 36. The annular space has an internal passage 48 that extends between the mouth end opening 38, and the open end of the internal passage 26 of the susceptor holder 14. The second portion 46 of the liquid reservoir 40 is located towards the connection end of the outer housing 36, and comprises an annular space defined between an inner surface of the outer housing 36 and an outer surface of the susceptor holder 14. The base 20 of the tubular susceptor holder 14 is provided with an annular, ribbed, elastomeric seal 50 that extends between the outer surface of the tubular susceptor 14 and the internal surface of the outer housing 36. The seal 50 provides a liquid tight seal between the susceptor holder 14 and the outer housing 36, ensuring that the second portion 46 of the liquid reservoir 40 is capable of holding the liquid aerosol forming substrate 42.

The first and second portions 44, 46 of the liquid reservoir 40 are fluidly isolated from each other by an aluminium foil seal 52, which is pierceable by the piercing elements 34 of the susceptor holder to allow liquid aerosol-forming substrate 42 to flow between the first and second portions 44, 46 of the liquid reservoir, as described in more detail below.

An air passage is formed through the cartridge 10 by the internal passage 26 of the susceptor holder 14, and the internal passage 48 through the first portion 44 of the liquid reservoir 40. The air passage extends from the air inlets 32 in the base 30 of the susceptor holder 14, through the internal passage 26 of the susceptor holder 14, and through the internal passage 48 of the first portion 44 of the liquid reservoir 40 to the mouth end opening 38. The air passage enables air to be drawn through the cartridge 10 from the connection end to the mouth end.

In the storage configuration, as shown in FIGS. 2a and 2b, the base 30 of the susceptor holder 14 extends out of the outer housing 36, and the piercing elements 34 of the susceptor holder 14 are spaced from the seal 52 in the direction of the connection end of the cartridge 10. In this configuration, the liquid aerosol-forming substrate 42 is held in the first portion 44 of the liquid reservoir 40, and is isolated from the second portion 46 of the liquid reservoir 40 by the seal 52. Accordingly, in the storage configuration the susceptor assembly 12 is isolated from the aerosol-forming substrate 42. Advantageously, sealing the liquid aerosol-forming substrate 42 in the first portion 44 of the liquid reservoir 40 may entirely prevent the liquid aerosol-forming substrate 42 from leaking out of the cartridge 10 while the cartridge is in the storage configuration.

In the use configuration, as shown in FIG. 2c, the susceptor holder 14 and the susceptor assembly 12 are pushed into the outer housing 36, towards the mouth end. As the susceptor holder 14 is pushed towards the mouth end of the outer housing 36, the seal 50 at the base 30 of the susceptor holder 14 slides over the inner surface of the outer housing 36, maintaining a liquid tight seal between the inner surface of the outer housing 36 and the outer surface of the tubular susceptor holder body as the base of the susceptor holder 14 is received in the outer housing. As the piercing elements 34 of the susceptor holder 14 are moved towards the mouth end, the piercing elements 34 contact and pierce the seal 52, allowing fluid communication between the first portion 44 of the liquid reservoir 40, and the second portion 46 of the liquid reservoir 40. The liquid aerosol-forming substrate 42 in the first portion 44 of the liquid reservoir 40 is released into the second portion 46 of the liquid reservoir 40, and the susceptor assembly 12 is exposed to the liquid aerosol-forming substrate 42.

In the use configuration, the mounting regions 22 of the first and second susceptor elements 16, 18, and the corresponding portions of the wicking element 20 that extend into the second portion 46 of the liquid reservoir 40, are able to draw the liquid aerosol-forming substrate 42 from the second portion 46 of the liquid reservoir 40 to the heating regions 24 of the first and second susceptor elements 16, 18. As a result, in the use configuration the cartridge 10 is ready for use to generate an aerosol by heating the aerosol-forming substrate 42. While it is the wicking element 20 that transports the aerosol-forming substrate from the reservoir to the first and second susceptor elements by capillary action, the electrically conductive filaments also rise to capillary action in the interstices between the filaments of the mesh to wet the first and second susceptor elements 16, 18. This wetting increases the contact area between the electrically conductive filaments of the susceptor element and the aerosol-forming substrate.

The aerosol-generating device 60 comprises a generally cylindrical housing 62 having a connection end and a distal end opposite the connection end. A cavity 64 for receiving the connection end of the cartridge is located at the connection end of the device 60, and an air inlet 65 is provided through the outer housing 62 at the base of the cavity 64 to enable ambient air to be drawn into the cavity 64 at the base.

The device 60 further comprises an inductive heating arrangement arranged within the housing 62. The inductive heating arrangement includes a pair of inductor coils 66, 68, control circuitry 70 and a power supply 72. The power supply 72 comprises a rechargeable nickel cadmium battery, that is rechargeable via an electrical connector (not shown) at the distal end of the device. The control circuitry 70 is connected to the power supply 72, and to the first and second inductor coils 66, 68, such that the control circuitry 70 controls the supply of power to the inductor coils 66, 68. The control circuitry 70 is configured to supply an alternating current to the first and second inductor coils 66, 68.

The pair of inductor coils comprises a first inductor coil 66, and a second inductor coil 68. The first inductor coil 66 is arranged at a first side of the cavity 64, and the second inductor coil 68 is arranged at a second side of the cavity 64, opposite the first inductor coil 66. Each of the inductor coils 66, 68 is substantially identical, and comprises a planar coil having a rectangular cross-section, formed from rectangular cross-section wire. Each of the inductor coils 66, 68 extends substantially in a plane, with the first coil 66 extending in a first plane and the second coil 68 extending in a second plane. The first and second planes are substantially parallel to each other, and extend substantially parallel to a central longitudinal axis of the cavity 64 at the connection end of the device 60. When the cartridge 10 is received in the cavity 64, the susceptor assembly 12 is arranged between the first and second inductor coils 66, 68, and the plane of the susceptor assembly 12 is arranged substantially parallel to the first and second planes.

Flux concentrators 69 are provided around each of the inductor coils in order to contain and concentrate the magnetic field within the cavity. The flux concentrators 69 may be formed from a magnetic material, such as iron.

Each of the first and second inductor coils 66, 68 is configured such that when the alternating current is supplied to the inductor coils 66, 68, the inductor coil generates an alternating magnetic field in the cavity 64. The alternating magnetic field generated by each of the inductor coils 66, 68 is directed substantially perpendicular to the plane of the susceptor assembly 12, and the susceptor elements 16, 18.

The inductive heating arrangement is also configured such that the second inductor coil 68 generates an alternating magnetic field in the cavity 64 that is equal and opposite to the alternating magnetic field generated in the cavity 64 by the first inductor coil 66. In this embodiment, the first and second inductor coils 66, 68 are connected together in series, and are substantially identical, but are wound in opposite senses. In this configuration, the first and second inductor coils 66, 68 generate alternating magnetic fields in the cavity 64 with substantially equal magnitudes, but in substantially opposite directions.

FIGS. 6a and 6b show the system of FIG. 1b but with the magnetic field lines of the magnetic fields generated by the inductor coils shown. FIG. 6a shows the magnetic field during a first half of the cycle of the alternating current. FIG. 6b shows the magnetic field during a second half of the cycle of the alternating current, with the magnetic field in the opposite direction. It can be seen that during both half cycles, the magnetic field is equal and opposite on opposite sides of the susceptor assembly 12. This provides a balance of forces on the susceptor assembly. The equal and opposite magnetic fields can be achieved by winding the first and second inductor coils in opposite directions and providing them with the same current. The equal and opposite magnetic fields can also be achieved by providing the second inductor coil with alternating current that is directly out of phase with the current provided to the first inductor coil.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10, as shown by the arrows in FIG. 1b. The ambient air flows through the cartridge 10 from the base 30 to the mouth end opening 38, through the air passage, and over the susceptor assembly 12.

The control circuitry 70 controls the supply of electrical power from the power supply 72 to the first and second inductor coils 66, 68 when the system is activated. The control circuitry 72 may include an airflow sensor (not shown), and the control circuitry 72 may supply electrical power to the inductor coils 66, 68 when user puffs on the cartridge 10 are detected by the airflow sensor. This type of control arrangement is well established in aerosol-generating systems such as inhalers and e-cigarettes.

When the system is activated, an alternating current is established in each of the inductor coils 66, 68, which generates an alternating magnetic field in the cavity 64 that penetrates the susceptor assembly 12, causing the heating regions 24 of the first and second susceptor elements 16, 18 to heat.

The alternating magnetic field passes through the susceptor assembly, inducing eddy currents in the first and second susceptor elements. The first and second susceptor elements 16, 18 heat up, reaching a temperature sufficient to vaporise the aerosol-forming substrate. Vaporised aerosol-forming substrate can escape from the wicking element 20 through the apertures in the mesh of the susceptors 16, 18. The susceptor assembly is configured to hold only a small volume of liquid aerosol-forming substrate, sufficient for a single user puff. This is advantageous because it allows that small volume of liquid to be vaporised rapidly, with minimal heat loss to other elements of the system or to liquid aerosol-forming substrate that is no vaporised.

Furthermore, the aerosol-forming substrate is primarily vaporised at the outer surfaces of the wicking element 20, closest to the first and second susceptor elements 16, 18. Because there are two susceptor elements 16, 18, the wicking element 20 is heated from two sides. Because the generated vapour may primarily be generated on the interface between the susceptor elements and the wicking element it does not need to pass through the bulk of the wicking element to escape the wicking element which would otherwise result in cooling and possible condensing of the vapour. Instead, the vapour passes through the permeable susceptor elements 16, 18 directly into the airflow passage.

While it is the wicking element 20 that transports the aerosol-forming substrate from the reservoir to the first and second susceptor elements by capillary action, the electrically conductive filaments also give rise to capillary action in the interstices between the filaments of the mesh to wet the first and second susceptor elements 16, 18. This wetting increases the contact area between the electrically conductive filaments of the susceptor element and the aerosol-forming substrate.

FIG. 7 is an exploded perspective view of another embodiment of a susceptor assembly 112 according to the disclosure. In this embodiment, the first and second susceptor 116, 118 elements consist of a perforated foil. The perforated foil is formed of AISI 430 stainless steel. In operation, vaporised aerosol-forming substrate escapes from the wicking element through the perforations 120 of the perforated foil. The wicking element 20 consists of rayon. The perforations 120 in FIG. 7 are not drawn to scale.

FIG. 8 is a perspective view of a further embodiment of a susceptor assembly 212 according to the disclosure. The first and second susceptor elements consist of an electrically conductive material deposited directly onto the wicking element 520. Only the first susceptor element 216 is visible in FIG. 6. The second susceptor element is on an underside of the wicking element 220 which is not visible.

The electrically conductive material has been deposited such that it forms a plurality of tracks that are distributed over the surface of the wicking element 220. These tracks form a mesh-like structure. In operation, vaporised aerosol-forming substrate may advantageously escape from the wicking element 220 through gaps 222 between the tracks. In this embodiment, the wicking element 220 consists of a porous ceramic material. Such a porous ceramic material is a suitable substrate for the manufacturing processes associated with the deposition of the electrically conductive material.

FIG. 9 is perspective view of a susceptor assembly 312 comprising a ceramic coating 302. The ceramic is a permeable ceramic that allows the vaporised aerosol-forming substrate to escape. The first and second susceptor elements and the wicking element are represented by line 304 in FIG. 9. FIG. 9 is not drawn to scale.

The coating 302 improves the robustness and strength of the susceptor assembly. Furthermore, when the susceptor assembly comprises a coating, the elements of the susceptor element can be retained together by that coating.

FIGS. 10a and 10b shows a susceptor assembly 412 having a different shape to that shown previously. In FIGS. 10a and 10b the susceptor assembly is shaped in the form of a cross. FIG. 10a shows a perspective view of susceptor assembly 412 and FIG. 10b shows a plan view of susceptor assembly 412. Each of the first susceptor element 416, the second susceptor element 418, and the wicking element 420 generally forms the shape of a cross, and each element has the same length and width dimensions.

Each of the pair of mounting regions 22 of susceptor elements 416,418 has a smaller surface area than the heating region 24. The length Iₘ of each of the mounting regions 22 is less than the length Iₙ of the heating region 24, and the width wₘ of each of the mounting regions 22 is less than the width wₙ of the heating region 24. In this embodiment, the heating region 24 has a length Iₙ of about 6.50 millimetres, and a width wₙ of about 3.50 millimetres, and each of the mounting regions 22 has a length Iₘ of about 2.50 millimetres, and a width wₘ of about 1.15 millimetres. As such, each of the first and second susceptor elements 16, 18 has a total maximum length of about 6.50 millimetres, and a total maximum width of about 5.80 millimetres.

Providing the first and second susceptor elements 416, 418 with mounting regions 22 having a reduced cross-section compared to the heating region 24, and at least partially comprising the mounting regions 22 from a non-magnetic material helps to reduce heating of the mounting regions 22 when the susceptor elements are penetrated by an alternating magnetic field. Such a configuration also helps to reduce heat transfer from the susceptor assembly 412 to the susceptor holder 14.

FIGS. 11a-11e show various other shapes of susceptor elements in accordance with different embodiments of the present disclosure.

FIG. 11a shows a susceptor element having two rectangular mounting regions 22 located at one side of a rectangular heating region 24. Each mounting region 22 is substantially identical, having a width and a length that are substantially shorter than the width and the length of the heating region 24. The mounting regions 22 are located at opposite ends of the heating region 24, such that the susceptor element generally forms the shape of the letter “C”.

FIG. 11b shows a susceptor element having two rectangular mounting regions 22 located at opposite sides of a rectangular heating region 24. Each mounting region 22 is substantially identical, having a width and a length that are substantially shorter than the width and the length of the heating region 24. The mounting regions 22 are located at the same end of the heating region 24, such that the susceptor element generally forms the shape of the letter “T”.

FIG. 11c shows a susceptor element having two rectangular mounting regions 22 located at opposite sides of a rectangular heating region 24. Each mounting region 22 is substantially identical, having a width and a length that are substantially shorter than the width and the length of the heating region 24. The mounting regions 22 are located at different positions along the length of the heating region 24, spaced from the ends of the heating region 24.

FIG. 11d shows a susceptor element having two rectangular mounting regions 22 located at opposite sides of a rectangular heating region 24. Each mounting region 22 is substantially identical, having a width and a length that are substantially shorter than the width and the length of the heating region 24. The mounting regions 22 are located at opposite ends of the heating region 24, such that the susceptor element generally forms the shape of the letter “S” or “Z”.

FIG. 11e shows a susceptor element having one rectangular mounting regions 22 located at one side of a rectangular heating region 24. The mounting region 22 has a width and a length that are substantially shorter than the width and the length of the heating region 24. The mounting region 22 is located at a central position along the length of the heating region 24.

FIGS. 12a-12i show further alternative shapes of susceptor elements in accordance with different embodiments of the present disclosure.

FIGS. 12a-12c show susceptor elements having substantially rectangular heating regions 24 and mounting regions 22, with each mounting region 22 of each susceptor element being substantially identical, and having a width and a length that is substantially shorter than the width and the length of the heating region 24.

FIG. 12a shows a susceptor element having two pairs of mounting regions 22 arranged at opposite ends of the heating region 24. Each pair of mounting regions comprises one mounting region 22 located at one side of the heating region 24, and one mounting region 22 located at the opposite side of the heating region 24, such that the susceptor element generally forms the shape of the letter “H”.

FIG. 12b shows a susceptor element having a pair of mounting regions 22 arranged at opposite sides of a heating region 24. The mounting regions 22 are located at the same central position along the length of the heating region 24, such that the susceptor element generally forms the shape of a cross.

FIG. 12c shows a susceptor element having two pairs of mounting regions 22 arranged at different positions along the length of the heating region 24, spaced from the ends of the heating region 24, and spaced from the other pair of mounting regions 22. Each pair of mounting regions 22 comprises one mounting region 22 located at one side of the heating region 24, and one mounting region 22 located at the opposite side of the heating region 24, at the same position along the length of the heating region 24.

FIGS. 12d-f show susceptor elements that are substantially similar to the susceptor elements shown in FIGS. 12a-c, wherein one or more of the edges of the mounting regions 22 or heating region 24 are angled, such that one or more of the mounting regions 22 and the heating region 24 are not rectangular.

FIG. 12d shows a susceptor element substantially similar to the susceptor element of FIG. 12a, with internal edges of the mounting regions 22 converging towards a central positon along the length of the heating region 24 as the mounting regions 22 extend away from the heating region 24.

FIG. 12e shows a susceptor element substantially similar to the susceptor element of FIG. 12b, with edges of the mounting regions 22 diverging in the direction of the length of the heating region 24 as the mounting regions 22 extend away from the heating region 24.

FIG. 12f shows a susceptor element substantially similar to the susceptor element of FIG. 12c, with edges of the mounting regions 22 diverging in the direction of the length of the heating region 24 as the mounting regions 22 extend away from the heating region 24.

FIGS. 12g-i show susceptor elements that are substantially similar to the susceptor elements shown in FIGS. 12a-c, wherein one or more of the edges of the mounting regions 22 or heating region 24 are curved, such that one or more of the mounting regions 22 and the heating region 24 are not rectangular.

FIG. 12g shows a susceptor element substantially similar to the susceptor element of FIG. 5a, with internal edges of the mounting regions 22 curved inwardly to form a concave inner edges of the mounting regions 22.

FIG. 12h shows a susceptor element substantially similar to the susceptor element of FIG. 5b, with edges of the mounting regions 22 curved outwardly to form convex mounting regions 22.

FIG. 12i shows a susceptor element substantially similar to the susceptor element of FIG. 12c, with edges of the mounting regions 22 curved outwardly to form convex mounting regions 22.

FIGS. 13a, 13b, 13c illustrate another embodiment of an aerosol-generating system. The system again comprises a cartridge 10 and a device 80. The cartridge 10 is identical to the cartridge shown in FIGS. 2a, 2b and 2c, and is shown in a use configuration. However, in this embodiment the device is configured so that the inductor coils are positioned inside the cartridge in use.

The aerosol-generating device 80 comprises a generally cylindrical housing 82 having a connection end and a distal end opposite the connection end. A cavity 81 for receiving the connection end of the cartridge is located at the connection end of the device 80, and an air inlet 85 is provided through the outer housing 82 at the base of the cavity 81 to enable ambient air to be drawn into the cavity at the base.

The device 80 further comprises an inductive heating arrangement arranged within the housing 82. The inductive heating arrangement includes a pair of inductor coils 86, 88, control circuitry 83 and a power supply 84. The power supply 84 comprises a rechargeable nickel cadmium battery, that is rechargeable via an electrical connector (not shown) at the distal end of the device. The control circuitry 83 is connected to the power supply 84, and to the first and second inductor coils 86, 88, such that the control circuitry 83 controls the supply of power to the inductor coils 86, 88. The control circuitry 83 is configured to supply an alternating current to the first and second inductor coils 86, 88.

The pair of inductor coils comprises a first inductor coil 86, and a second inductor coil 88. The first inductor coil 86 and the second inductor coil 88 extend into the cavity 81, and are held within coil housings 89. The first inductor coil 86 is positioned on one side of the susceptor assembly 12 when the cartridge is coupled to the device and the second inductor coil 88 is positioned on an opposite side of the susceptor assembly to the first inductor coil 86. Each of the inductor coils 86, 88 is substantially identical, and comprises a planar coil having a rectangular cross-section, formed from rectangular cross-section wire. FIG. 13b, which shows the device rotated through 90 degrees relative to FIG. 13a, illustrates the rectangular shape of the second inductor coil 88 more clearly. Each of the inductor coils 86, 88 extends substantially in a plane, with the first coil 86 extending in a first plane and the second coil 88 extending in a second plane. The first and second planes are substantially parallel to each other, and extend substantially parallel to a central longitudinal axis of the cavity 81 at the connection end of the device 80. When the cartridge 10 is received in the cavity 81, the susceptor assembly 12 is arranged between the first and second inductor coils 86, 88, and the plane of the susceptor assembly 12 is arranged substantially parallel to the first and second planes. FIG. 13c is an end view of the device showing the position of the coil housings 89 within the cavity 81. The device and cartridge housing are provided with a keying arrangement to ensure that the cartridge can be received in the cavity 81 only in a desired orientation, ensuring the susceptor assembly is positioned between the inductor coils.

As in the embodiment of FIG. 1, each of the first and second inductor coils 86, 88 is configured such that when the alternating current is supplied to the inductor coils 86, 88, the inductor coil generates an alternating magnetic field in the cavity 81. The alternating magnetic field generated by each of the inductor coils 86, 88 is directed substantially perpendicular to the plane of the susceptor assembly 12, and the susceptor elements.

The inductive heating arrangement is also configured such that the second inductor coil 88 generates an alternating magnetic field in the cavity 81 that is equal and opposite to the alternating magnetic field generated in the cavity by the first inductor coil 86. In this embodiment, the first and second inductor coils 86, 88 are connected together in series, and are substantially identical, but are wound in opposite senses, as illustrated schematically in FIG. 14. In this configuration, the first and second inductor coils 86, 88 generate alternating magnetic fields on either side of the susceptor assembly with substantially equal magnitudes, but in substantially opposite directions.

FIG. 14 is a schematic illustration of the coil arrangement of FIGS. 13a, 13b and 13c. It can be seen that the first and second inductor coils 86, 88 are connected in series but are wound in an opposite sense to one another. So when an alternating current is supplied to the inductors coils they generate alternating magnetic fields in an opposite direction to one another. One major surface of the susceptor assembly experiences the magnetic field generated by the first inductor coil 86 and the opposite major surface of the susceptor assembly experiences the magnetic field generated by the second inductor coil 86. The susceptor assembly, and in particular the susceptor elements are positioned substantially equidistant between the first and second inductor coils, and so this arrangement means that the forces generated by the magnetic fields on the susceptor element or elements, such as the Lorentz force, are balanced. This reduces deformation and movement of the susceptor elements when compared to an arrangement using only a single inductor coil. Furthermore, if there is any misalignment of the susceptor assembly, this arrangement will tend to move the susceptor assembly to a central position, equidistant between the first and second inductor coils.

FIGS. 15a and 15b show schematic illustrations of a cartridge 10 for an aerosol generating device according to another embodiment of the present disclosure. The cartridge 10 shown in FIG. 15a is substantially similar to the cartridge 10 shown in FIG. 2, and like features are denoted by like reference numerals.

The cartridge 10 comprises two susceptor assemblies 12, mounted in a susceptor holder 14. Each susceptor assembly 12 is planar, and thin, and is shaped in the form of the letter “C”. Each susceptor assembly 12 has the same three elemented configuration as the susceptor assembly 12 of FIGS. 3a-3c, having a wicking element arranged between a first and second susceptor element (not shown). Each susceptor element has a rectangular heating region and two mounting regions arranged at one side of the heating region, at opposite ends of the heating region, as shown in FIG. 15a.

The susceptor holder 14 comprises a tubular body, comprising a side wall defining an internal passage 26, having open ends. Two pairs of openings 28 extend through the side wall, each pair of openings 28 having one opening located at one side of the susceptor holder 14, and another opening located at the opposite side of the susceptor holder 14.

In this embodiment, each of the two susceptor assemblies 12 is arranged substantially outside of the internal passage 26 of the tubular susceptor holder 14, and extends in a plane parallel to a central longitudinal axis of the susceptor holder 14. The heating region of each susceptor element is arranged entirely outside of the internal passage 26, and each of the mounting regions extends through one of the openings 28 in the side wall of the susceptor holder.

The susceptor holder comprises a base 30 that partially closes one end of the internal passage 26. In this embodiments, the base 30 forms a liquid tight seal with the internal passage 26, such that the internal passage is configured to hold a liquid. The base 30 comprises a plurality of air inlets 32; however, the air inlets 32 are arranged outside of the internal passage 26.

The susceptor holder 14 further comprises a pair of piercing elements 34 extending from an inner surface of the side wall, into the internal passage 26, towards the central longitudinal axis of the susceptor holder 14.

The cartridge 10 further comprises an outer housing 36 that generally forms a hollow cylinder, defining an internal space in which the susceptor assembly 12 and the susceptor holder 14 are contained. The outer housing 36 forms a first portion of the cartridge 10, and the susceptor assembly 12 and the susceptor holder 14 form a second portion of the cartridge 10. The second portion of the cartridge is slidable relative to the first portion of the cartridge between a storage configuration, as shown in FIG. 15a, and a use configuration, as shown in FIG. 15b.

The cartridge 10 has a mouth end defining a mouth end opening 38, and a connection end configured for connection of the cartridge 10 to an aerosol-generating device. The susceptor assembly 12 and the susceptor holder 14 are located towards the connection end of the cartridge 10. The external width of the outer housing 36 is greater at the mouth end of the cartridge 10 than at the connection end, which are joined by a shoulder 37.

A liquid reservoir 40 is defined in the cartridge for holding a liquid aerosol-forming substrate 42. The liquid reservoir 40 is divided into two portions, a first portion 44 and a second portion 46. The first portion 44 of the liquid reservoir 40 is located towards the mouth end of the outer housing 36, and comprises a cylindrical space defined by an internal wall of the outer housing 36. The second portion 46 of the liquid reservoir 40 is located towards the connection end of the outer housing 36, and comprises a cylindrical space defined by the internal passage 26 of the susceptor holder 14.

The first and second portions 44, 46 of the liquid reservoir 40 are fluidly isolated from each other by an aluminium foil seal 52, which is pierceable by the piercing elements 34 of the susceptor holder to allow liquid aerosol-forming substrate 42 to flow between the first and second portions 44, 46 of the liquid reservoir.

A first passage 48 is defined between an outer surface of the internal wall defining the first portion 44 of the liquid reservoir 40, and an inner surface of an external wall of the outer housing 36. The first passage 48 extends between the mouth end opening 38, and the susceptor holder 14. A second passage 49 is defined between the inner surface of the external wall of the outer housing 36 and the outer surface of the susceptor holder 14. The base 30 of the tubular susceptor holder 14 is provided with an annular, ribbed, elastomeric seal 50 that extends between the outer surface of the tubular susceptor 14 and the internal surface of the external wall of the outer housing 36. The seal 50 provides an air tight seal between the susceptor holder 14 and the outer housing 36.

An air passage is formed through the cartridge 10 by the first and second passages 48, 49. The air passage extends from the air inlets 32 in the base 30 of the susceptor holder 14, through the second passage 49, and through the first passage 48 to the mouth end opening 38. The air passage enables air to be drawn through the cartridge 10 from the connection end to the mouth end.

In the storage configuration, as shown in FIG. 15a, the base 30 of the susceptor holder 14 extends out of the outer housing 36, and the piercing elements 34 of the susceptor holder 14 are spaced from the seal 52 in the direction of the connection end of the cartridge 10. In this configuration, the liquid aerosol-forming substrate 42 is held in the first portion 44 of the liquid reservoir 40, and is isolated from the second portion 46 of the liquid reservoir 40 by the seal 52.

In the use configuration, as shown in FIG. 15b, the susceptor holder 14 and the susceptor assembly 12 are pushed into the outer housing 36, towards the mouth end. As the susceptor holder 14 is pushed towards the mouth end of the outer housing 36, the seal 50 at the base 30 of the susceptor holder 14 slides over the inner surface of the outer housing 36, maintaining an air tight seal between the inner surface of the outer housing 36 and the outer surface of the tubular susceptor holder body as the base of the susceptor holder 14 is received in the outer housing. As the piercing elements 34 of the susceptor holder 14 are moved towards the mouth end, the piercing elements 34 contact and pierce the seal 52, allowing fluid communication between the first portion 44 of the liquid reservoir 40, and the second portion 46 of the liquid reservoir 40. The liquid aerosol-forming substrate 42 in the first portion 44 of the liquid reservoir 40 is released into the second portion 46 of the liquid reservoir 40, and the susceptor assembly 12 is exposed to the liquid aerosol-forming substrate 42. In the use configuration, the mounting regions 22 of the susceptor elements, and the corresponding portions of the wicking element that extend into the second portion 46 of the liquid reservoir 40, are able to draw the liquid aerosol-forming substrate 42 from the second portion 46 of the liquid reservoir 40 to the heating regions 24 of the susceptor elements.

FIGS. 16a and 16b show an aerosol-generating system comprising the cartridge 10 of FIGS. 15a and 15b in the use configuration, received in an aerosol-generating device 60. FIG. 16b shows the aerosol-generating system of FIG. 16a rotated through 90 degrees about the longitudinal axis of the system. The aerosol-generating device 60 is substantially similar to the aerosol-generating device 60 shown in FIGS. 1a and 1b, and like features are denoted by like reference numerals.

The aerosol-generating device 60 comprises a generally cylindrical housing 62 having a connection end and a distal end opposite the connection end. A cavity 64 for receiving the connection end of the cartridge is located at the connection end of the device 60, and an air inlet 65 is provided through the outer housing at the base of the cavity 64 to enable ambient air to be drawn into the cavity 64 at the base.

The device 60 further comprises an inductive heating arrangement arranged within the housing 62. The inductive heating arrangement includes two pairs of inductor coils, control circuitry 70 and a power supply 72. Only one pair of inductor coils 90, 91 is visible in FIG. 16b. The power supply 72 comprises a rechargeable nickel cadmium battery, that is rechargeable via an electrical connector (not shown) at the distal end of the device. The control circuitry 70 is connected to the power supply 72, and to the inductor coil 66, such that the control circuitry 70 controls the supply of power to the inductor coil 66. The control circuitry 70 is configured to supply an alternating current to the inductor coil 66.

The inductor coils comprise a pair of opposing planar inductor coils positioned around each susceptor assembly 12 when the cartridge 10 is received in the cavity 64. The inductor coils have a size a shape matching the size and shape of the heating regions of the susceptor elements.

The inductor coils 90, 91 are configured such that when the alternating current is supplied to the inductor coils, the inductor coils generate opposing alternating magnetic fields on opposite sides of the susceptor assemblies 12. The alternating magnetic fields generated by the inductor coils are directed substantially perpendicular to the plane of the susceptor assemblies 12, and the susceptor elements.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10, as shown by the arrows in FIG. 10a. The ambient air flows through the cartridge 10 from the base 30 to the mouth end opening 38, through the air passage, and over the susceptor assemblies 12.

The control circuitry 70 controls the supply of electrical power from the power supply 72 to the inductor coils 90, 91 when the system is activated. The control circuitry 72 may include an airflow sensor (not shown), and the control circuitry 72 may supply electrical power to the inductor coil 66 when user puffs on the cartridge 10 are detected by the airflow sensor.

When the system is activated, an alternating current is established in the inductor coils 90, 91, which generates alternating magnetic fields in the cavity 64 that penetrate the susceptor assembly 12, causing the heating regions of the susceptor elements to heat. Liquid aerosol-forming substrate in the second portion 44 of the liquid reservoir 40 is drawn into the susceptor assemblies 12 through the wicking elements to the heating regions of the susceptor elements. The liquid aerosol-forming substrate at the heating regions of the susceptor elements is heated, and volatile compounds from the heated aerosol-forming substrate are released into the air passage of the cartridge 10, which cool to form an aerosol. The aerosol is entrained in the air being drawn through the air passage of the cartridge 10, and is drawn out of the cartridge 10 at the mouth end opening 38 for inhalation by the user.

FIGS. 17a and 17b show a susceptor element according to another embodiment of the disclosure.

The susceptor element 100 comprises a woven mesh of filaments. Some of the woven filaments 102 extend in a warp direction, and some of the woven filaments 104 extend in a weft direction, substantially perpendicular to the warp direction.

The filaments 104 extending in the weft direction comprise a magnetic material, such as AISI 409 stainless steel. The filaments 102 extending in the warp direction comprise a non-magnetic material, such as AISI 316 stainless steel. The mesh is sintered such that electrical bonds are created at the contact points between the filaments 102 extending in the warp direction and the filaments 104 extending in the weft direction.

The susceptor element 100 is a planar element, extending substantially in a plane. The filaments 102 extending in the warp direction are woven with the filaments 104 extending in the weft direction such that the filaments 102 extending in the warp direction extend further outwards from the plane of the susceptor element 100 than the filaments 104 extending in the weft direction. In other words, the filaments 102 extending in the warp direction define the maximum thickness of the susceptor element 100.

As the filaments 102 extending in the warp direction define the maximum thickness of the susceptor element 100, a susceptor holder 14 in contact with the susceptor element 100 only comes into contact with the filaments 102 extending in the warp direction, as shown in FIG. 17a.

Since the filaments 102 extending in the warp direction are not comprised of a magnetic material, the filaments 102 extending in the warp direction are not directly heated by the induction of eddy currents, or hysteresis losses when the susceptor element 100 is exposed to an alternating magnetic field.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±{5%} of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-17. (canceled)

18. An electrically heatable aerosol-generating system, comprising:
at least one inductor coil;
a power supply connected to the at least one inductor coil and configured to provide an alternating current to the at least one inductor coil to generate an alternating magnetic field;
a housing containing a reservoir of aerosol-forming substrate; and
a substantially planar susceptor assembly configured to be heated by the alternating magnetic field and comprising a first susceptor element, a second susceptor element, and a wicking element in fluid communication with the reservoir, the first and the second susceptor elements being integral with or fixed to the wicking element,
wherein a space is defined between the first and the second susceptor elements, the wicking element occupying the space and the reservoir being positioned outside the space, and
wherein the first and the second susceptor elements are fluid permeable.

19. The electrically heatable aerosol-generating system according to claim 18, wherein the susceptor assembly, or a heating region of the susceptor assembly, holds between 2 millilitres and 10 millilitres of liquid aerosol-forming substrate.

20. The electrically heatable aerosol-generating system according to claim 18, wherein the first and the second susceptor elements each comprise a mesh, flat spiral coil, fibres, or fabric of electrically conductive filaments.

21. The electrically heatable aerosol-generating system according to claim 18, wherein the first and the second susceptor elements each comprise an electrically conductive material printed or otherwise deposited on to the wicking element as a film or a plurality of tracks.

22. The electrically heatable aerosol-generating system according to claim 18, wherein the first and the second susceptor elements each comprise a perforated foil.

23. The electrically heatable aerosol-generating system according to claim 18,
wherein the substantially planar susceptor assembly extends parallel to a first plane, and
wherein the electrically heatable aerosol-generating system is configured such that the at least one inductor coil provides a magnetic field at the susceptor assembly that is normal to the first plane.

24. The electrically heatable aerosol-generating system according to claim 18,
further comprising an airflow passage extending between an air inlet and an air outlet,
wherein airflow in the airflow passage passes over a surface of the first susceptor element and a surface of the second susceptor element.

25. The electrically heatable aerosol-generating system according to claim 24, wherein the reservoir comprises a fluid channel extending towards the substantially planar susceptor assembly.

26. The electrically heatable aerosol-generating system according to claim 24, wherein the housing comprises an inner wall and an outer wall such that an internal passage is defined by the inner wall, the internal passage being surrounded by a space defined between the inner wall and the outer wall.

27. The electrically heatable aerosol-generating system according to claim 26, wherein the airflow passage is at least partially defined by the internal passage and the reservoir is at least partially defined by a space surrounding the internal passage.

28. The electrically heatable aerosol-generating system according to claim 26, wherein the reservoir is at least partially defined by the internal passage and the airflow passage is at least partially defined by an annular space surrounding the internal passage.

29. The electrically heatable aerosol-generating system according to claim 18, wherein the susceptor assembly is surrounded by a permeable electrically insulating coating.

30. The electrically heatable aerosol-generating system according to claim 18, wherein the susceptor assembly has a thickness of no greater than two millimetres.

31. The electrically heatable aerosol-generating system according to claim 18, further comprising a susceptor assembly holder onto which the susceptor assembly is mounted.

32. The electrically heatable aerosol-generating system according to claim 31, wherein the susceptor assembly holder is tubular and has at least one sidewall.

33. The electrically heatable aerosol-generating system according to claim 18,
further comprising an aerosol-generating device and a cartridge configured to be used with the device,
the aerosol-generating device comprising the at least one inductor coil, the power supply, and a device housing configured to engage at least a portion of the cartridge when the cartridge is used with the aerosol-generating device, and
the cartridge comprising the susceptor assembly and a cartridge housing,
wherein the at least one inductor coil is positioned around or adjacent the susceptor assembly when the cartridge is engaged with the aerosol-generating device.

34. A cartridge for an electrically heatable aerosol-generating system, the electrically heatable aerosol-generating system comprising an aerosol-generating device, the cartridge being configured to be used with the aerosol-generating device, wherein the aerosol-generating device comprises: a device housing configured to engage at least a portion of the cartridge when the cartridge is used with the aerosol-generating device, at least one inductor coil, and a power supply connected to the at least one inductor coil and configured to provide an alternating current to the at least one inductor coil so that the inductor coil generates an alternating magnetic field within the cartridge, the cartridge comprising:
a cartridge housing defining a reservoir containing an aerosol-forming substrate; and
a substantially planar susceptor assembly configured to be heated by the alternating magnetic field and comprising a first susceptor element, a second susceptor element, and a wicking element in fluid communication with the reservoir, the first and the second susceptor elements being integral with or fixed to the wicking element,
wherein a space is defined between the first and the second susceptor elements, the wicking element occupying the space and the reservoir being positioned outside the space, and
wherein the first and the second susceptor elements are fluid permeable.
